(19) United States
(12) Patent Application Publication
(10) Pub. No.: US 2024/0309698 A1
(43) Pub. Date: Sep. 19, 2024

(54) SHUTTER-TYPE ROLLABLE DEVICE FOR OCCLUDING AN OPENING, COMPRISING WATERTIGHT SEALING MEANS

(71) Applicant: MELAMED LAURENT, CHELLES (FR)

(72) Inventors: Laurent MELAMED, CHELLES (FR); Hubert BLONDET, Villette d'Anthon (FR); Florian GABERT, Montpellier (FR); Luc DIONIS DU SEJOUR, LYON (FR)

(21) Appl. No.: 18/262,315

(22) PCT Filed: Sep. 1, 2021
(86) PCT No.: PCT/EP2021/074172

§ 371 Date: Jul. 20, 2023

(30) Foreign Application Priority Data
Feb. 4, 2021 (WO) PCT/FR2021/050212

(51) Int. Cl. E06B 9/17; E06B 9/00; E06B 9/15; E06B 9/58

(52) U.S. Cl. CPC E06B 9/17076; E06B 9/15; E06B 9/58; E06B 2009/005; E06B 2009/007; E06B 2009/1522; E06B 2009/1544; E06B 2009/588

(57) ABSTRACT

A rollable device for occluding an opening of a residential building, includes a frame mounted in the opening and provided with at least two lateral guiding slides with a U-shaped cross-section, in order to define a general closure plane, and a set of transverse slats hinging relative to each other in pairs by the respective longitudinal edges thereof, the slats sliding within the two slides between a first inactive raised position in which the slats are wound about an upper transverse axis and a second active lowered position in which the slats are unwound and form an apron for closing the opening. The cross-section of the lateral slides is greater than the thickness of the slats and in the second active lowered position, the slats adopt a vertical accordion configuration in the lateral slides and form, relative to each other in pairs, an angle other than 180°.

### CROSS REFERENCE TO RELATED APPLICATIONS

This application is a National Stage of International Application No. PCT/EP2021/074172 having an International Filing Date of 1 Sep. 2021, which designated the United States of America, and which International Application was published under PCT Article 21(2) as WO Publication No. 2022/167109, which claims priority from and the benefit of French Patent Application No. PCT/FR2021/050212, filed on 4 Feb. 2021, the disclosures of which are incorporated herein by reference in their entireties.

### BACKGROUND

### Field

The present disclosure relates to the field of buildings, whether public or private, residential, community or industrial, and more particularly to the field of closing, occluding and above all protecting the doors, windows or bay windows in a residential building such as a private or community dwelling, or an industrial building such as a shop, factory, garage/car park or warehouse against flooding.

### BRIEF DESCRIPTION OF RELATED DEVELOPMENTS

Various ways of occluding a building opening currently exist. One particularly widespread solution, whether for residential or industrial buildings, is to use a roller shutter or sectional roll-up door made of slats that slide within lateral slides forming a frame inside the opening.

These shutters, whether manual or motorised, can have several functions that can be combined. The first function is, of course, that of closing off the opening, in particular that of preventing anyone from entering the building (dwelling or industrial/commercial premises) and/or that of placing a room (bedroom for example) in darkness.

Another known function is that of providing the building with thermal and/or acoustic insulation.

Other shutters also have an anti-intrusion function thanks to a reinforced structure.

However, there is no effective solution for protecting/sealing against flooding, i.e. the penetration of a fluid such as water through, under and/or at the sides of the slats.

Alternatives to roller shutters are known, such as temporary barriers (NOAQ BOXWALL®), sandbag-based barriers (SANDMASTER®) or biodegradable absorbent polymer crystal-based barriers (FLOOD SAX®), inflatable barriers (NOAQ TUBEWALL®, SNAKE SELF-F®, HYDROSNAKE®) or removable barriers (ANTI FLOOD BARRIERS®), or panels that can be added to doors/roller shutters (DAM EASY FLOOD BARRIERS®). However, these solutions require to anticipate flooding and are inconvenient to install. Moreover, they protect against low water levels (1 m at most).

Passive solutions exist, such as the FLOOD BREAK® system, which uses a barrier that pivots upwards under the pressure of the water, but they require side walls to be of any use and extensive work to the building, in particular to the floor. The FLOW DEFENCE® solution uses a barrier that automatically rises vertically out of the ground thanks to a flotation system, but it requires extensive work to the floor.

Prior art solutions are thus either non-existent or unsuitable and of questionable effectiveness because they suffer from at least one of the following drawbacks: they are extremely time-consuming and costly to install because they are highly invasive from a structural point of view (extensive and irreversible works must be carried out, heavy and bulky structure), they are slow to activate (with a significant risk of flooding still remaining), they are not strong enough, not watertight enough, or they are not passive/require a person to be present to activate them, etc.

Attempts have already been made to overcome this problem by applying a watertight veil/film along the slats of the roller shutter, but this solution appears incomplete, not very effective in terms of watertightness, and not very resistant in the long term (lack of mechanical strength of the veil over time). Furthermore, the seals provided around the shutter are too simplistic and cannot currently guarantee even a partial seal, and the slats seem prohibitively expensive because they are made from carbon.

Finally, the problems associated with resistance to infractions and wind gusts (storms), which the disclosure also sets out to solve, have not yet found satisfactory solutions that are simple to manufacture and use, at an affordable overall cost.

### SUMMARY

The present disclosure aims to overcome these drawbacks with a totally innovative approach.

To this end, according to a first aspect, the present disclosure relates to a roller shutter-type rollable occlusion device for closing an opening such as a door, a window or a bay window of a residential building such as a private or collective dwelling, or of an industrial building such as a shop, a factory, a garage/car park or a warehouse, said closing device comprising an external frame mounted in the opening and provided with at least two lateral guiding slides with a U-shaped cross-section facing one another, in order to define a general closure plane, and a set of transverse slats hinging relative to one another in pairs by the respective longitudinal edges thereof, the slats sliding within the two slides between a first inactive raised position in which said slats are rolled up around an upper transverse shaft and a second active lowered position in which said slats are unrolled and form an apron for closing said opening, the device being characterised in that:
the cross-section of the lateral slides is greater than the thickness of the slats,
in the second, active lowered position of the closure apron, the slats adopt a vertical accordion configuration in the lateral slides and form, relative to one another consecutively in pairs, front and rear angles not equal to 180°, and
in a third lowered position, the slats adopt a protective and fluid-tight configuration, referred to as the position under frontal load, when the closure apron is subjected to a force on a front face, for example the pressure exerted by a height/column of water, so that the slats form, relative to one another consecutively, an angle (a; B) as close as possible to 180°, or even equal to 180°, so that the closure apron is disposed in the general closure plane or parallel thereto.

The disclosure is implemented according to the aspects and alternative aspects described hereinbelow, which can be considered singly or according to any combinations technically possible.

Advantageously, in the second active lowered position, the slats are alternately inclined in a repeated and regular manner at identical front and rear angles respectively, which facilitates rolling/unrolling and provides better resistance to water pressure.

More specifically, in the second active lowered position, the absolute values of the front and rear angles are identical, so that the accordion shape of the apron is regular.

Moreover, the absolute value of each rear or front angle lies between about 90° and 179°, preferably between about 125° and 175°, and even more advantageously between about 150° and 170° so as to reduce the dimensions of the slides and thus the overall dimensions of the device (its thickness) without compromising its strength/sealing.

According to one specific aspect, the device comprises a first longitudinal means of passive sealing between the slats which withstands a low fluid pressure, so as to act, for example, when a small quantity of water presses against the front face of the apron, even when the closure apron is in the second, lowered position.

Thus, advantageously, the first longitudinal low-pressure passive sealing means includes at least, on a lower longitudinal edge of a given first slat, a prominent transverse rib and, on an upper longitudinal edge of a slat that is below said given first slat, a transverse groove enclosing a first flexible, transverse seal, said prominent, transverse rib increasingly compressing said first flexible, transverse seal in the transverse groove so as to progressively compress the latter as the slats move from the second position to the third lowered sealing position, so as to strengthen the fluid-tight seal of the device.

According to an alternative aspect, the first longitudinal low-pressure passive sealing means includes at least, on the lower longitudinal edge of a given first slat, a transverse groove enclosing a flexible, transverse seal and, on an upper longitudinal edge of a slat that is below said given first slat, a prominent, transverse rib, said prominent, transverse rib increasingly compressing said first flexible, transverse seal in the transverse groove so as to progressively compress the latter as the slats move from the second position to the third lowered sealing position, in order to strengthen the fluid-tight seal of the device.

It should be noted in these two aspects that not all of the first transverse seals disposed between two consecutive slats will necessarily be progressively compressed as the slats move from the second position to the third lowered sealing position. More specifically, due to the bulging belly shape of the slats when subjected to the frontal force, the pressure exerted on some of the first seals will gradually be relieved as the slats pivot, without any loss of sealing.

Preferably, the first transverse seal is a strip with a polygonal, circular or oval cross-section, and is preferably hollow to improve the compression-sealing function.

More specifically, the first seal is made of silicone. According to one alternative aspect, the first seal is made of EPDM rubber.

According to another aspect of the present disclosure, the device further comprises a second longitudinal means of passive sealing between the slats which can withstand a high fluid pressure.

Preferably, the second longitudinal, passive, high-pressure sealing means includes, on a rear face of a front part of a given first slat, a transverse recess receiving a second flexible, transverse seal cooperating with the front of a hinge hook of a slat below said given first slat, the front of said hinge hook increasingly compressing the second flexible, transverse seal so as to progressively compress the latter as pressure is exerted on the front face of the closure apron in order to seal the device against said fluid.

Alternatively, the second longitudinal, passive, high-pressure sealing means includes, on a front face of a hinge hook of a given first slat, a transverse recess enclosing a second flexible, transverse seal cooperating with a rear face of a front part of a second slat above said given first slat, said rear face of the front part of the second slat increasingly compressing the second transverse seal in the transverse recess so as progressively to compress the latter as pressure is exerted on the front face of the closure apron in order to seal the device against said fluid.

Similarly, not all second transverse seals disposed between two consecutive slats in these two aspects will necessarily be progressively compressed as the slats move from the second position to the third lowered sealing position. More specifically, due to the bulging belly shape of the slats when subjected to the frontal force, the pressure exerted on some of the second seals will gradually be relieved as the slats pivot, without any loss of sealing.

Advantageously, the second transverse seal is a strip with a polygonal, preferably rectangular, or circular or oval, cross-section.

According to another aspect of the present disclosure, the device further includes:
a lower, transverse channel connecting the two lateral slides and intended to receive at least one bottom end slat of the closure apron, and
at least a third longitudinal, passive, low-pressure sealing means.

Preferably, the third longitudinal, passive, low-pressure sealing means includes:
a third transverse seal rigidly connected to a lower longitudinal edge of the bottom end slat, and
a bottom wall of the lower channel so that, in the third lowered sealing position, the third transverse seal is compressed against said bottom wall in order to seal the device against said fluid.

According to an alternative aspect, the third flexible, transverse seal is positioned in a transverse groove rigidly connected to a bottom wall of the lower channel so that, in the third lowered sealing position, the third flexible, transverse seal is compressed between a lower longitudinal edge of the bottom end slat and said transverse groove in order to seal the device against said fluid.

Preferentially, the lower channel includes a protective covering comprising a hinged upper cover, a leaf spring bearing against a bottom wall of said lower channel and said closure cover, and a hook provided on a rear wall of the channel and capable of cooperating with a corresponding hook provided along the lower edge of the bottom slat to form an anti-unhooking/separation device so that, in the second position, the third flexible, transverse seal bears against the closure cover and, in the third lowered sealing position, the hooks are engaged to prevent any inadvertent raising of the closure apron.

More specifically, the anti-unhooking/separation device consists of a plurality of hooks spaced apart and distributed transversally along the lower edge of the bottom end slat.

According to yet another aspect of the present disclosure, each lateral slide houses a fifth lateral sealing means.

More specifically, the fifth lateral sealing means includes a flexible stopper seal penetrating recesses in the respective lateral ends of each of the slats.

In a complementary manner, the fifth lateral sealing means further includes, for each lateral slide, a U-shaped vertical seal that can move transversally between a distant position in which it is distant from each stopper seal and a proximate position in which the latter is pressurised by means of a vertical clamping bar and a pressing member compressing said U-shaped vertical seal against each stopper seal as frontal pressure is exerted on the front face of the closure apron in order to seal the device laterally against said fluid.

Advantageously, the fifth lateral sealing means further includes a lateral activation bar that can move in translation along each slide and that acts on the pressing member to move the vertical U-shaped seal from the distant position into the proximate position.

According to one specific aspect of the present disclosure, the pressing member includes:
a pressure shoe,
a bistable lever in the form of a square supporting the pressure shoe and hinged about a shaft attached to the corresponding lateral slide so as to take a first stable, inactive, retreated position in which the pressure shoe is distant from the vertical clamping bar and a second stable, active, advanced position in which the pressure shoe clamps the vertical U-shaped seal against each stopper seal, and
an extension spring to hold the lever in each of the stable positions.

Alternatively, the pressing member includes a series of pairs of vertically stacked springs controlled by the displacement of the lateral activation bar, said springs each having an unmoving end and the other end connected to a common movable point and acting on the vertical clamping bar to cause it to move from a first stable, inactive, retreated position in which the vertical U-shaped seal is distant from each stopper seal into a second stable, active, advanced position in which the vertical U-shaped seal bears against each stopper seal.

According to another alternative aspect, the pressing member includes a series of vertically-stacked double pantographs controlled by the displacement of the lateral activation bar, each first pantograph being hinged about an unmoving shaft and about a moving shaft linked to the activation bar and each second pantograph being hinged about said moving shaft and provided with a bearing end acting on the vertical clamping bar to cause it to move from a first stable, inactive, retreated position in which the vertical U-shaped seal is distant from each stopper seal into a second stable, active, advanced position in which the vertical U-shaped seal bears against each stopper seal.

According to an alternative aspect, the pressing member includes a series of vertically-stacked single pantographs controlled by the displacement of the lateral activation bar, each pantograph being hinged about a moving shaft linked to the activation bar and has a bearing end acting on the vertical clamping bar to cause it to move from a first stable, inactive, retreated position in which the vertical U-shaped seal is distant from each stopper seal into a second stable, active, advanced position in which the vertical U-shaped seal bears against each stopper seal.

In a complementary manner, the device includes a cable rotated about at least one roller and provided with a pin for the vertical displacement of said lateral activation bar.

Advantageously, the device further includes a lever finger linked to the lateral activation bar and mounted so as to pivot about a shaft rigidly connected to a lateral slide, said finger being rotated by the movement of the pin rigidly connected to the cable so that, in a first movement of the cable causing the pin to descend, the latter pivots the lever so as to clamp the vertical U-shaped seal against each stopper seal, and, in a second, opposite movement of the cable causing the pin to rise, the latter pivots the lever in the opposite direction about its shaft so as to move the vertical U-shaped seal away from each stopper seal.

Preferably, the cable is tensioned between the drive shaft of the closure apron and a lower tension roller.

According to an alternative aspect, the cable is tensioned between an upper roller and a lower roller, the cable being rotated by an independent stepper motor.

According to another alternative aspect, the lateral activation bar is displaced by means of a bistable electromagnet having two extreme positions.

According to another aspect of the present disclosure, the lower channel includes a locking and unlocking system comprising a latch which is tilted into its locking position when the lateral activation bar is lowered when the closure apron is completely lowered and returns to its unlocking position when said lateral activation bar is raised before the apron is raised.

Advantageously, the latch includes a main body hinged about an unmoving shaft between two extreme open and closed positions, and two fingers capable of acting on a catch rigidly connected to the activation bar to hold the latter in the third lowered sealing position.

According to another alternative aspect, the pressing member includes cylinders bearing against the vertical clamping bar to move the latter from a first stable, inactive, retreated position, in which the vertical U-shaped seal is distant from each stopper seal, into a second stable, active, advanced position, in which the vertical U-shaped seal bears against each stopper seal.

According to yet another alternative aspect, the pressing member includes a series of cams hinged about a common shaft and acting on the vertical clamping bar, said cams passing from a first stable, inactive, retreated position in which the vertical U-shaped seal is distant from each stopper seal into a second stable, active, advanced position in which the vertical U-shaped seal bears against each stopper seal.

According to an alternative aspect, the pressing member includes a reversible expansion joint which bears against each stopper seal and fills the space between the latter and the bottom wall of the corresponding lateral slide.

Advantageously, the reversible expansion joint is of the hydraulic or pneumatic type.

Alternatively, the reversible expansion joint is of the chemical expansion type.

According to another aspect of the operating kinematics of the device, the pressing member includes:
a pressure shoe,
a bistable lever in the form of a square supporting the pressure shoe and hinged about a shaft attached to the corresponding lateral slide so as to take a first stable, inactive, retreated position in which the pressure shoe is distant from the vertical clamping bar and a second stable, active, advanced position in which the pressure shoe clamps the vertical U-shaped seal against each stopper seal,
a vertically movable, lateral ribbon including first long, transverse strands, each connected to the end of a first long arm of the lever, and second short, transverse strands, each connected to the end of a first short arm of the same lever, and
extension springs to hold each lever in each of the stable positions.

Alternatively, the system includes a first ribbon for the short strand and a second ribbon for the long strand, the ribbons being activated independently of one another or in a linked manner (when the first ribbon is pulled on, the second ribbon is automatically released, and vice-versa).

In an alternative aspect, the pressing member includes:
a pressure shoe,
a bistable lever in the form of a square supporting the pressure shoe and hinged about a shaft attached to the corresponding lateral slide so as to take a first stable, inactive, retreated position in which the pressure shoe is distant from the vertical clamping bar and a second stable, active, advanced position in which the pressure shoe clamps the vertical clamping bar against the vertical U-shaped seal in order to compress the latter against each stopper seal,
a vertically-movable, lateral ribbon including transverse strands, each connected to the end of a first long arm of the lever, said strip being tensioned against the return force of the springs when the vertical clamping bar is in its first retreated position, and
extension springs to hold each lever when the clamping bar is in its second advanced position.

In this aspect, the pressure shoe is in the active “unstressed” position on the ribbon, such that the sealing position of the system is considered to be the initial position. This in particular ensures the sealing of the closure apron in the event of a power cut, because it is the positive action on the ribbon, by exerting a mechanical tensile force thereon, that disengages the pressure shoe and thus the pressure of the vertical clamping bar against the vertical U-shaped seal.

According to an alternative aspect of the fifth lateral sealing means, the latter includes two longitudinal profiles disposed inside the two lateral slides, on either side of the ends of the slats, each longitudinal profile being provided, for each slat disposed facing said longitudinal profile, with a first lateral seal and a second lateral seal, said profile being hinged along a vertical axis between a first inactive position in which the first lateral seal does not exert pressure on the stopper seal of the given slat, and at least a second active position in which the first lateral seal exerts lateral pressure on said stopper seal and the second lateral seal exerts pressure against a portion of the lateral slide as pressure is exerted on the front face of the closure apron, in the lowered position thereof, in order to seal the device laterally against said fluid. This solution, with its simplified design and increased efficiency, reduces the number of parts to be designed and the maintenance required in the event of a malfunction. According to one specific aspect, the longitudinal profile includes a curved crescent shape defining a lever hinged about a pivot formed by an internal rib of the corresponding lateral slide, a first free end of said profile being provided internally with the first lateral seal, whereas a second opposite end, located on the other side of the pivot, is disposed facing the second lateral seal, and when the longitudinal profile is in the second position, the first free end thereof compresses the first lateral seal against the stopper seal of a given slat and the rear of the second free end thereof compresses the second lateral seal against a portion of the corresponding slide. This solution has simple kinematics with a short-displacement lever system that reduces the overall dimensions of the lateral sealing means.

According to one preferred aspect, the slide has a hollow recess close to the pivot for receiving the second lateral seal in order to hold it in position.

Similarly, the rear of the second free end of the profile is provided with a hollow inner recess for receiving the second lateral seal in order to hold it in position.

According to an alternative aspect of the longitudinal profile, the latter includes a curved crescent shape defining a lever hinged about a pivot formed by an internal rib of the corresponding lateral slide, a first free end of said profile being provided internally with the first lateral seal, whereas a rear rib, fitted between the two free ends of the profile, is disposed facing the second lateral seal, and when the longitudinal profile is in the second position, the first free end thereof compresses the first lateral seal against the stopper seal of a given slat and the rear rib thereof compresses the second lateral seal against a rear edge of the corresponding slide.

Advantageously, the first free end of the longitudinal profile is provided with a hollow inner recess for receiving the first lateral seal in order to hold it in position.

According to a particularly interesting feature of the present disclosure, the second end of the longitudinal profile includes a hook disposed facing a vertical rear slot formed in the thickness of at least some of the lower slats, such that the pressure exerted by the water on the front face of the closure apron, when in its lowered position, causes said given slats to retreat and the hook to slide along an inclined plane of said vertical slot, in turn causing the longitudinal profile to progressively rotate about the pivot and increasing the force exerted on the stopper seal as said pressure increases.

In a complementary manner, the fifth lateral sealing means further includes a system for activating the longitudinal profiles, which system is disposed in the lower part of each lateral slide, said activation system causing at least the bottom slat to advance from the front face towards the rear face of the closure apron as the slats descend along the lateral slides, so as to tilt the longitudinal profiles from the first position into the second position.

More specifically, each activation system includes a ramp having a vertical plane that is inclined from the rear face to the front face of the closure apron along which the bottom slat slides as it descends.

In particular, each activation system further includes an upper roller connected to one end of a given slat and adapted to bear against a lateral distribution plate, which is itself placed on a vertically-moving, longitudinal bar resting on a lower, curved, lateral clamping sheet, such that the descent of the upper roller exerts a vertical force directed downwards on the distribution plate, which causes the vertical bar to descend, pressing on the lower, curved clamping sheet which thus presses laterally on the longitudinal profile to cause it to rotate vertically and create the lateral seal on the given lower slats.

Alternatively, the device includes a sensor for detecting the rise of fluid along the closure apron and an actuator which automatically triggers the activation of said fifth lateral sealing means during said rise of fluid.

According to a particularly interesting feature of the present disclosure, each lateral slide is provided, on at least one of the walls thereof, with a vertical rib penetrating a vertical groove in each slat so as to block the latter in the lateral slide at least in the third lowered sealing position.

According to a specific aspect of the present disclosure, the slats are aluminium profiles with a hollow cross-section provided longitudinally with reinforcing ribs spaced apart from one another.

### BRIEF DESCRIPTION OF THE FIGURES

Other advantages, purposes and features of the present disclosure will appear upon reading the following description, provided for explanatory purposes only and in no way limiting the disclosure, with reference to the accompanying drawings, in which:

FIG. 1 is a perspective view of a shutter-type rollable occlusion device with hinged longitudinal slats in accordance with the present disclosure, the device being in a closed position,

FIG. 2 is a longitudinal, partial, sectional view of the rollable occlusion device in FIG. 1 in a fully open position,

FIG. 3 is a longitudinal, partial, sectional view of the rollable occlusion device in FIG. 1 in a lowered intermediate position,

FIG. 4 is a longitudinal, sectional view of the rollable occlusion device in FIG. 1 when subjected to frontal pressure from a fluid such as water, for example during a flood,

FIG. 5 is a close-up, sectional view of a plurality of slats showing various longitudinal sealing means,

FIG. 6 is a close-up view of that shown in FIG. 5,

FIG. 7 is a close-up view of an alternative aspect to that shown in FIG. 6, wherein the structure has been inverted,

FIG. 8 is a close-up, perspective view of a lower part of the rollable occlusion device illustrating a system for protecting against the intrusion of elements such as dust in a first closed position and a pick-resistance system including a hook,

FIG. 9 is a view similar to FIG. 8, wherein the system for protecting against the intrusion of elements such as dust is in a second open position and the hook of the pick-resistance system is in a first inactive position,

FIG. 10 is a view similar to FIG. 9, wherein the system for protecting against the intrusion of elements such as dust remains in the second open position, whereas the hook of the pick-resistance system is in a second active position,

FIG. 11 is a close-up, perspective, sectional view of an alternative aspect to that shown in FIG. 9,

FIG. 12 is a perspective view of a slat illustrating an alternative aspect of the pick-resistance system in FIGS. 8 to 11,

FIG. 13 is a close-up, perspective view of a lateral end of a slat provided with a stopper seal,

FIG. 14 is a close-up, exploded, perspective view of that shown in FIG. 13, in which the stopper seal is separated from the slat,

FIG. 15 is a close-up, partial, transverse sectional view of a lateral portion of the rollable occlusion device illustrating a lateral sealing means in which the stopper seal is in an uncompressed state,

FIG. 16 is a view similar to FIG. 15, in which the stopper seal of the lateral sealing means is compressed by a vertical clamping bar,

FIG. 17 is a partial, sectional view of a lateral portion of the rollable occlusion device illustrating a displacement system that in particular includes a lateral activation bar in a first fully-retreated position,

FIG. 18 is a view similar to FIG. 17, in which the lateral activation bar is in a second, partially advanced position,

FIG. 19 is a view similar to FIG. 18, in which the lateral activation bar is in a third, fully advanced position,

FIG. 20 is a diagrammatic, close-up, front view of a system for displacing the lateral activation bar vertically,

FIG. 21 is a close-up, perspective view of that shown in FIG. 20, illustrating part of the system for displacing the lateral activation bar,

FIG. 22 is a close-up, front view of that shown in FIG. 21, in which the system for displacing the lateral activation bar is in a first position,

FIG. 23 is a view similar to FIG. 22, in which the system for displacing the lateral activation bar is in a second position,

FIG. 24 is a view similar to FIG. 22, in which the system for displacing the lateral activation bar is in a third position,

FIG. 25 is a view similar to FIG. 22, in which the system for displacing the lateral activation bar is in a fourth position,

FIG. 26 is a view similar to FIG. 22, in which the system for displacing the lateral activation bar is in a fifth position,

FIG. 27 is a view similar to FIG. 22, in which the system for displacing the lateral activation bar is in a sixth position,

FIG. 28 is a view similar to FIG. 22, in which the system for displacing the lateral activation bar is in a seventh position,

FIG. 29 is a view similar to FIG. 22, in which the system for displacing the lateral activation bar is in an eighth position,

FIG. 30 is a close-up, perspective view of a lower portion of the rollable occlusion device illustrating a hinged latch in a closed position,

FIG. 31 is a sectional view of that shown in FIG. 30, in which the hinged latch is in an open position,

FIG. 32 is a view similar to FIG. 31, in which the hinged latch is in the closed position,

FIG. 33 is a diagrammatic, close-up, front view of an alternative aspect of the system for displacing the lateral activation bar using a stepper motor, a cable provided with a weight attached to said lateral activation bar and tension rollers,

FIG. 34 is a diagrammatic, side view of that shown in FIG. 33,

FIG. 35 is a close-up, perspective view illustrating another system for displacing the lateral activation bar using a series of stacked cams,

FIG. 36 is a close-up, perspective view showing another system for displacing the lateral activation bar using a series of stacked pairs of double springs in a first retreated position,

FIG. 37 is a sectional view of that shown in FIG. 36, with the system for displacing the lateral activation bar with double springs in a second advanced position,

FIG. 38 is a close-up, longitudinal, sectional view showing another system for displacing the lateral activation bar using a series of stacked double pantographs in a first retreated position,

FIG. 39 is a view similar to FIG. 38, in which the double pantographs are in a second advanced position,

FIG. 40 is a view similar to FIG. 38 showing another system for displacing the lateral activation bar using a series of stacked single pantographs in a first retreated position,

FIG. 41 is a view similar to FIG. 40, in which the single pantographs are in a second advanced position,

FIG. 42 is a close-up, transverse sectional view showing another system for displacing the lateral activation bar using an expansion joint,

FIG. 43 is a diagrammatic, close-up, front view of an alternative aspect of the system for displacing the lateral activation bar using electromagnets,

FIG. 44 is a view similar to FIGS. 38 and 40 showing another system for displacing the lateral activation bar using a series of stacked double cables in a first retreated position,

FIG. 45 is a view similar to FIG. 44, in which the double cables are in a second advanced position,

FIG. 46 is a view similar to FIG. 44 showing another system for displacing the lateral activation bar using a single cable in a first retreated position,

FIG. 47 is a view similar to FIG. 46, in a second advanced position,

FIG. 48 is a partial, perspective view showing a notch formed at a lateral end of the slats of the rollable occlusion device,

FIG. 49 is a diagrammatic, close-up, transverse sectional view of the rollable occlusion device,

FIG. 50 is a diagrammatic, close-up, transverse sectional view showing a front seal,

FIG. 51 is a view similar to FIG. 50, showing a rear seal,

FIG. 52 is a partial, horizontal, sectional view of a lateral part of the device of the present disclosure showing a fifth lateral sealing means in a first position,

FIG. 53 is a partial, horizontal, sectional view of a lateral part of the device of the present disclosure illustrating the fifth lateral sealing means in a second position,

FIG. 54 is a view illustrating an alternative aspect to that shown in FIG. 53,

FIG. 55 is a view illustrating another alternative aspect to that shown in FIGS. 53 and 54,

FIG. 56 is a view illustrating another alternative aspect to that shown in FIGS. 53 to 55,

FIG. 57 is a view illustrating another alternative aspect to that shown in FIGS. 53 to 56,

FIG. 58 is a close-up, perspective view of a first lower element of a system for activating the fifth lateral sealing means,

FIG. 59 is a longitudinal sectional view of that shown in FIG. 58,

FIG. 60 is a close-up, perspective view of an upper element of a second lateral element of the system for activating the fifth lateral sealing means,

FIG. 61 is a transverse sectional view of that shown in FIG. 60, and

FIG. 62 is a transverse sectional view of a lower part of the second lateral element shown in FIG. 60.

### DETAILED DESCRIPTION

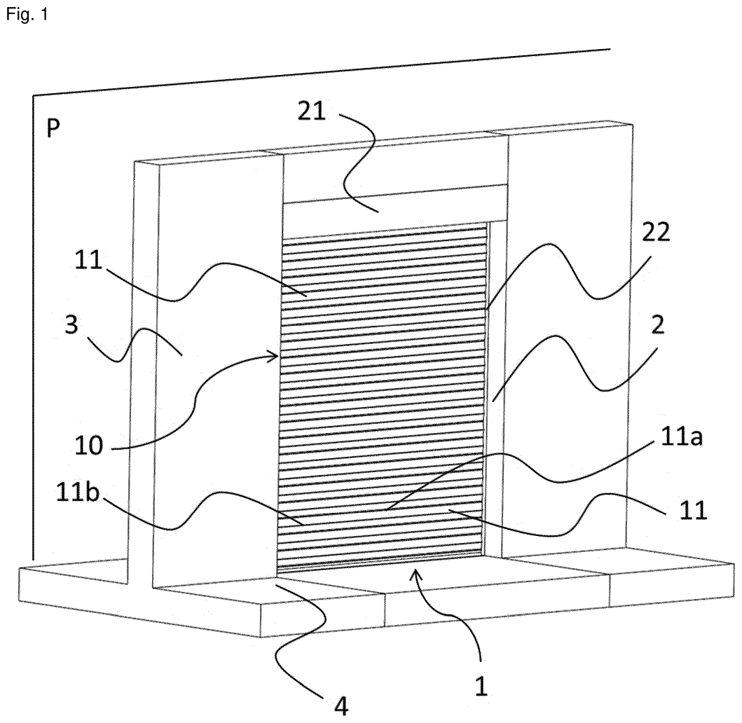

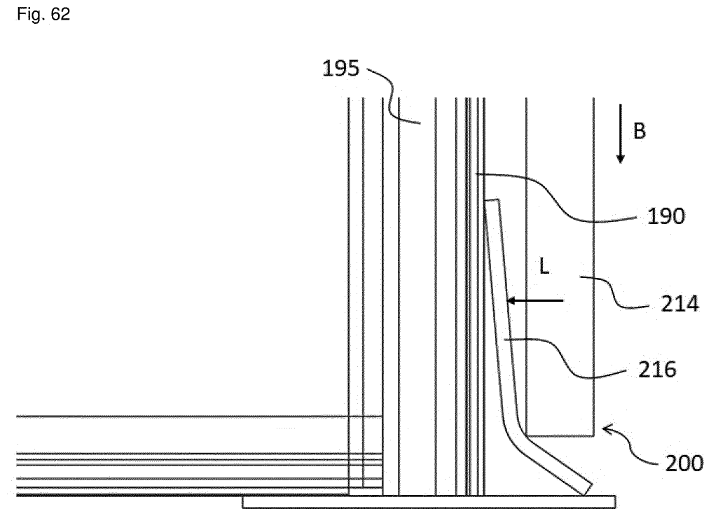

FIGS. 1 to 62 show different aspects and operating modes for a roller shutter- or sectional door-type rollable occlusion device 1.

This roller shutter 1 is intended to be installed in any type of industrial building (warehouse, factory, etc.), commercial building (shop, restaurant, offices, etc.), private building (home, garage, etc.), community building (apartment block, cinema, shopping centre, etc.) or public building (government building, school, etc.), in order to close off/protect an opening 2 made in a wall 3, such as a wall standing on the floor 4, whether or not fitted with a window, a bay window (unmoving or sliding), a door, a French window or any other equivalent equipment. In the remainder of the description, the opening 2 provided in the wall 3 and where the roller shutter 1 is installed will define a substantially vertical general closure plane P.

Thanks to a very specific and ingenious design, which will be described hereinbelow, the rollable occlusion device 1 of the present disclosure is designed in such a way as, in particular but not only, to protect the interior of buildings from floods, storms and certain break-ins.

To this end, as illustrated in FIGS. 1 to 4, the rollable occlusion device 1 typically includes a closure apron 10 comprising a series of transverse slats 11 with a hollow core, which slats are hinged to one another longitudinally by the cooperation between their respective profiles, and a stiff external frame 20. These slats 11 are hinged to one another at their respective upper and lower longitudinal edges 11a and 11b, and extend transversally within the frame 20, which is rigidly connected inside the opening 2 made in the wall 4.

More specifically, the closure apron 10 includes specific top and bottom slats 12 and 13 respectively, between which a multitude of intermediate slats 11 are hinged, preferably alternately identical depending on their parity (even/odd). The closure apron 10 also includes a front face 10f oriented towards the outside of the wall 4 and a rear face 10d oriented towards the inside of the building.

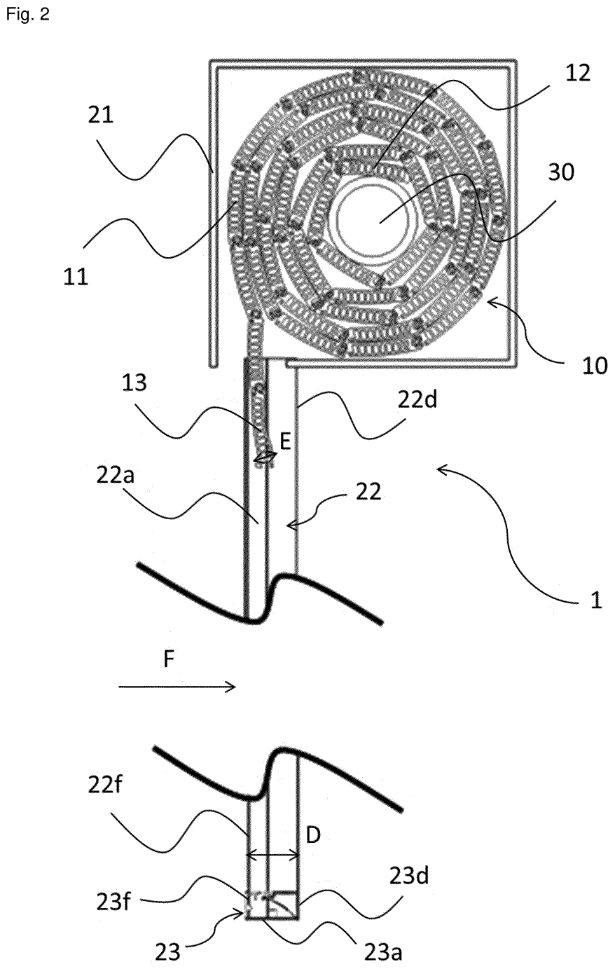

The frame 20 typically includes:
an upper box-type casing 21 housing, in particular, a drive shaft 30 for driving the roller shutter 10, and said shutter 10 when the latter is entirely rolled up in the inactive position (FIG. 2),
two lateral slides 22, each having, from a top view, a U-shape facing one another with a bottom wall 22a connected to the wall 3 and two fins parallel to one another, i.e. a front wall 22f and a rear wall 22d, according to the external/internal direction of installation of the device 1 in the building to be protected, and
a lower channel 23, also having a U-shaped profile with a bottom wall 23b preferably resting on the floor 4 and two fins parallel to one another, i.e. a front wall 23f and a rear wall 23d, according to the external/internal direction of installation of the device 1 in the building to be protected.

Firstly, the lateral slides 22 must be watertight. They are thus preferably embedded in the wall 3, for example by fastening with a thermosetting-type resin. The lower channel 23 should also be embedded in the floor 4 to prevent the closure apron 10 from bending.

The first condition for ensuring watertightness is thus the stiffness of the closure apron 10. More specifically, under pressure from the water (arrows F), this closure apron 10 will deform. More specifically, the lowest slats 11 (those directly subjected to the pressure from the water, as well as some slats above the water level) will cave in, in a more or less rounded manner, at the centre to form a belly with both vertical and transverse/horizontal curvature, with the slats subject to the greatest frontal stress (water pressure) caving in the most towards the inside of the building. If the apron deforms too much, there is a risk that the slats 11 will move apart from one another or even come out of the lateral slides 22 and the device 1 will be ineffective, or potentially destroyed. Aluminium was thus chosen for the hollow slats 11, 12 and 13, because of its good price/stiffness/strength ratio and the ease with which the profiles could be extruded. The slats 11, 12 and 13 must be able to pivot relative to one another to guarantee good flexibility and thus easy rolling around the drive shaft 30. The detail lies in the profile of the hooking of the slats 11, between the upper longitudinal edge 11a of a given slat 11 and the lower edge 11b of a higher slat. To achieve this, curved, hook-shaped profiles of a known type are provided to connect the slats vertically to one another while allowing them to pivot longitudinally (i.e. substantially horizontally) as explained hereinabove so that they are correctly positioned in the lateral slides 22.

The first idea is to position the slats 11 in an “accordion” shape when the closing shutter 10 is closed, using an angle support system. This support, or seat, is created naturally by the angle between each slat and guarantees the various types of watertight seal that will be described hereinbelow.

The slats 11 of the closure apron 10 are thus intended to slide freely in the vertical direction from top to bottom and vice-versa between the lateral walls 22f and 22d and the bottom wall 22a of the lateral slides 22, which thus act as guide rails of sorts. For this purpose, the cross-section of the U-shape of the lateral slides 22, i.e. the distance D between the front wall 22f and the rear wall 22d, is greater than the thickness E of the slats 11.

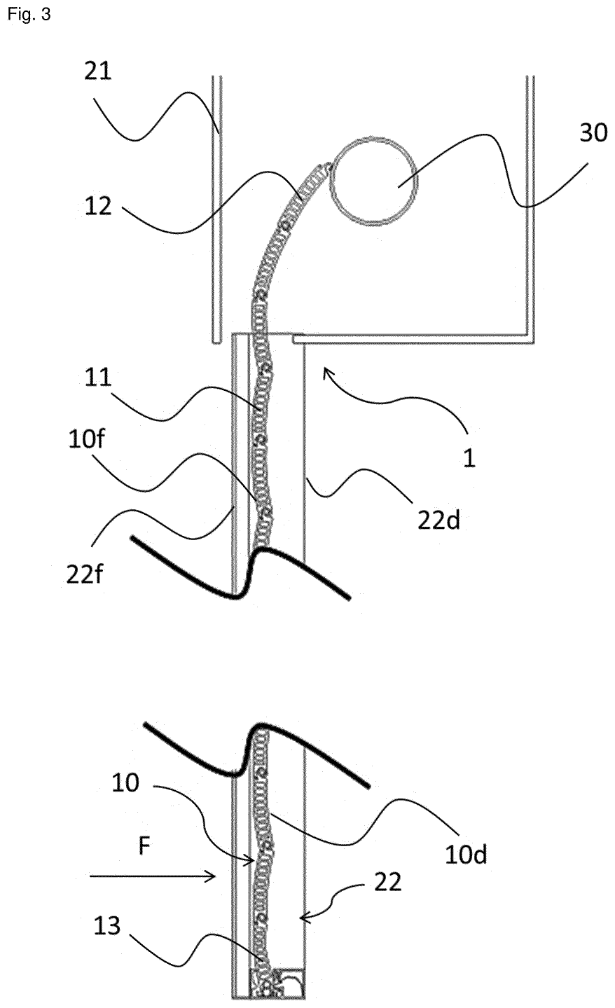

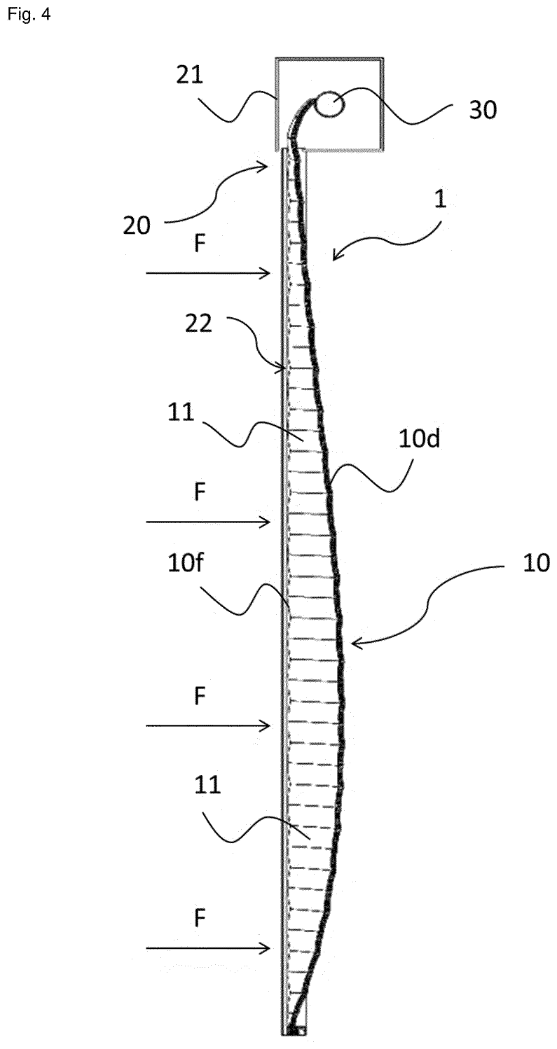

More specifically, as illustrated successively by FIGS. 2 to 4, the closure apron 10 can take three main positions, i.e. a first inactive, raised position (FIG. 2) in which the slats 11 are rolled up one on top of the other around the drive shaft 30 (connected to a drive device not shown), a second active, lowered position (FIG. 3) in which said slats 11 are unrolled and form the closure apron 10 closing said opening 2, which already provides a first watertight seal (or other seal) thanks in particular to the means of sealing between the slats which will be described hereinbelow, and a third reinforced sealing position (FIG. 4) when the front face 10f of the closure apron 10 is subjected to a force F, for example the pressure exerted by a height/column of water during a flood, the force of the wind during a (violent) storm or the weight of an individual trying to force open the closure apron 10 (for example by hitting it with his/her shoulder, foot or a battering ram).

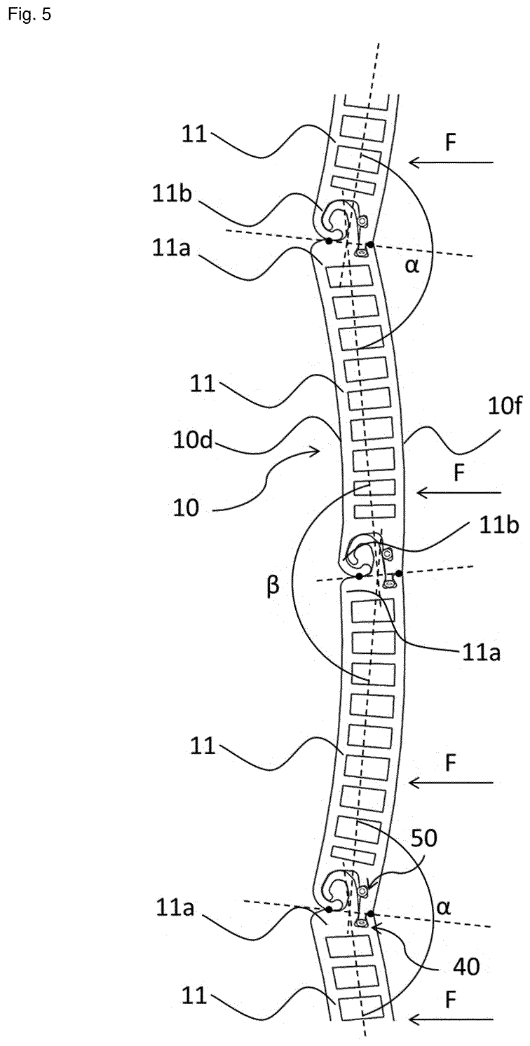

In the second position illustrated in FIGS. 3 and 5, and contrary to the prior art, the slats 11 adopt a vertical “accordion” configuration in the lateral slides 22 and form with one another a front angle α between two consecutive, respectively “even” and “odd” slats (or vice-versa) and a rear angle β between two consecutive “odd” and “even” slats, these two angles being different from 180°. Preferably, the angles α and β are opposed (one is positive and the other is negative) and have possibly identical absolute values, so that the closure apron 10 forms a regular “accordion” shape with alternating inclination of the slats 11 (one inclined in one direction, the other in the other, and so on, depending on their parity). The absolute values of the angles α and β are, for example, between about 90° and 179°, preferably between about 125° and 175°, and advantageously between 150° and 170°.

In the third stressed configuration, illustrated in FIG. 4, the slats 11 take, as previously indicated, a third lowered protection and fluid-tight position when the closure apron 10 is subjected to a frontal force F as described hereinabove. In this position, two consecutive slats 11 form an angle α or B with one another, the absolute value of which angle is close to 180° (the slats pivot relative to one another), or even equal to 180°, so that the closure apron 10 is virtually flat and disposed in the general closure plane P. This notion of a flat closure apron, which is fictional, will be explained hereinbelow. It should be remembered that in the third position, some of the slats will pivot alternately in one direction and then the other, relative to one another, in pairs, over a certain height corresponding as a whole to the height of the water exerting frontal pressure on the closure apron 10.

In other words, this means that the slats 11 hinge with one another under the effect of the frontal pressure F so that the angles α and β will progressively change. For example, the angles α and ß can thus change from +150° and −150° to +180° and −180° respectively (“flat” apron), or even slightly beyond, for example +190° and −190°. In reality, the pressure of the water will deform the closure apron 10 to give it the shape of a “belly” caving in towards the inside of the building. It is thus not really flat, but the slats 11 that will pivot will be almost flat if looking from the slides 22.

Thus, transversally speaking, the further towards the middle of the closure apron 10 you look, when starting from a given lateral slide and heading towards the opposite slide, the more each slat 11 will be bent/cave towards the inside of the building, with a point of inflection of the “belly” at the point where the pressure from the water is the greatest. Similarly, vertically speaking, the higher up you look from the ground and from the bottom slat to the water level, the less the slats 11 will be caved in.

The sealing of the device 1, which constitutes a particularly innovative point of the present disclosure, concerns a plurality of zones, i.e. an inter-slat seal (“low” and “high” pressure seal), combining both the stiffness of the closure apron 10 and its flexibility to prevent water from infiltrating between the slats 11, a lower seal at the lower channel 23 and at the bottom slat 13, to prevent water from infiltrating at the bottom of the closure apron 10, and at least a double lateral seal at the slides 22 and at the lateral ends of the slats 11 as well as in front of/behind the latter where necessary.

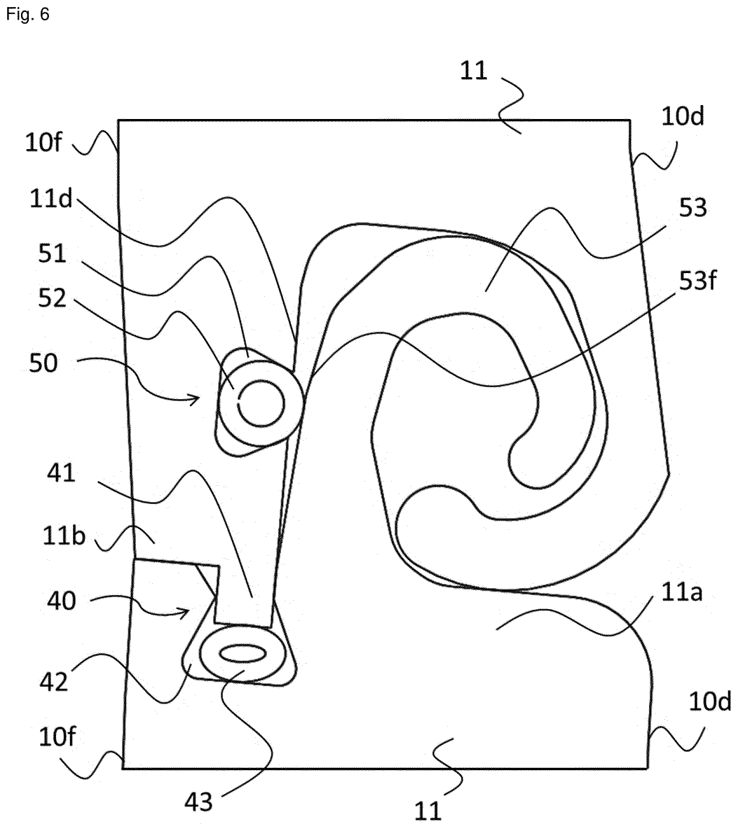

As can be seen in FIGS. 5 and 6, the closure apron 10 is fitted with a first longitudinal means 40 for creating a passive seal between the slats, which seal withstands low pressure and is used in particular when the frontal pressure F exerted on the slats 11 is low or near-zero.

More specifically, the first low-pressure, longitudinal, passive sealing means 40 includes, on the lower longitudinal edge 11b of a given first slat 11, a prominent transverse rib 41 and, on an upper longitudinal edge 11a of a slat 11 below said given first slat 11, a transverse groove 42 enclosing a first flexible transverse seal 43. These elements 41 to 43 are positioned closer to the front surface 10f of the closure apron 10 than to the rear surface 10b thereof.

Thus, as the slats 11 hinge together along the respective edges 11a and 11b thereof in order to move from the second accordion-shaped configuration to the third flat configuration, the protruding transverse rib 41 increasingly compresses the first flexible transverse seal 43 in its groove 42 as said slats 11 pivot to make the device 1 fluid-tight by forming a low-pressure seal.

It should be noted that not all of the first transverse seals disposed between two consecutive slats will necessarily be progressively compressed as the slats move from the second position to the third lowered sealing position. More specifically, because of the bulging belly shape of the slats subjected to the frontal force, the pressure exerted on some of the first seals will gradually be relieved as the slats pivot, without any loss of watertightness, as they will already have been stressed in the second position.

As can also be seen in FIGS. 5 and 6, the closure apron 10 is fitted with a second longitudinal means 50 for creating a passive seal between the slats, which seal withstands high pressure and is used in particular when the frontal pressure F exerted on the slats 11 is high or even very high (flooding at a high water level, strong storm, pressure from an individual using force or using a battering ram).

More specifically, the second high-pressure, longitudinal, passive sealing means 50 includes, on a rear face 11d of the front part 10f of a given first slat 11 of the closure apron 10, a transverse recess 51 receiving a second flexible transverse seal 52 cooperating with a front face 53f of a hinge hook 53 of a slat 11 below said given first slat 11. These elements are also positioned closer to the front surface 10f of the closure apron 10 than to the rear surface 10d thereof. Thus, the greater the force F (rise of water over several tens of centimetres to more than a metre, depending on the width of the slats 11 of device 1—force of the wind during a strong storm—individual using force or a battering ram) exerted on the front face 10f of the closure apron 10, the more the front 53a of the hinge hook 53 compresses the second flexible transverse seal 52 inside the transverse groove 51 so as to compress it progressively as the slats 11 move from the second accordion-shaped configuration to the third flat configuration in order to make the device 1 fluid-tight, resistant to storms and able to withstand any intrusion attempts.

Similarly, not all second transverse seals disposed between two consecutive slats in these two aspects will necessarily be progressively compressed as the slats move from the second position to the third lowered sealing position. More specifically, because of the bulging belly shape of the slats subjected to the frontal force, the pressure exerted on some of the second seals will gradually be relieved as the slats pivot, without any loss of watertightness, as they will already have been stressed in the second position.

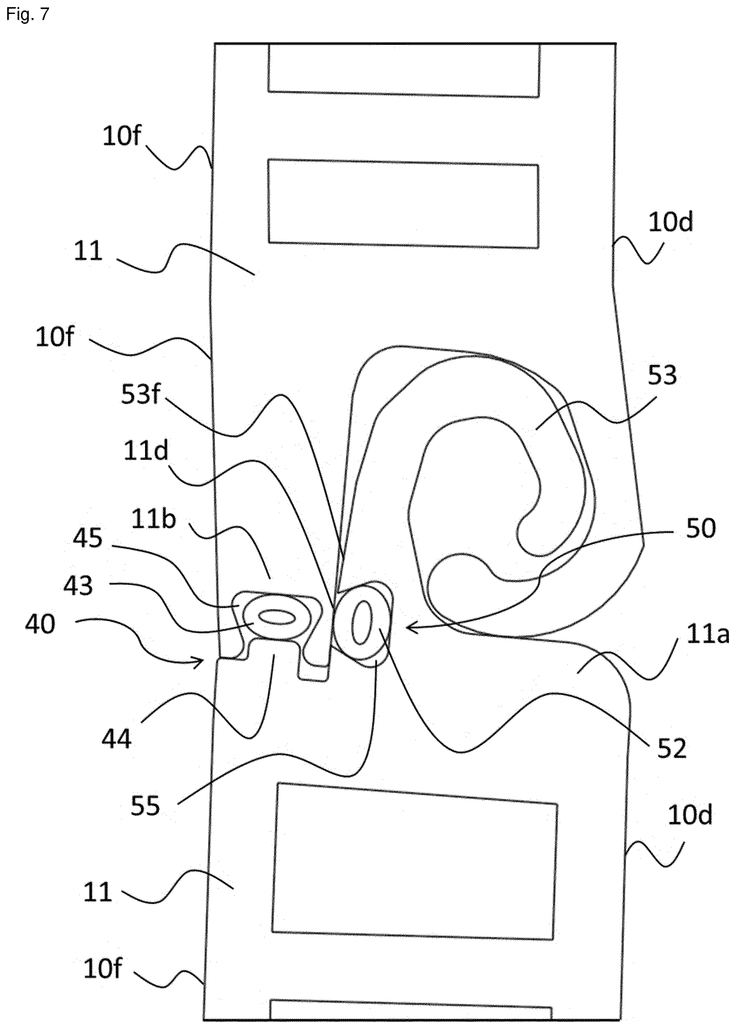

According to an alternative aspect illustrated in FIG. 7, the first low-pressure, longitudinal, passive sealing means 40 includes, on the upper longitudinal edge 11a of a given first slat 11, a prominent transverse rib 44 and, on a lower longitudinal edge 11b of a slat 11 above said given first slat, a transverse groove 45 enclosing a first flexible transverse seal 43. These elements 41 to 43 are positioned closer to the front surface 10f of the closure apron 10 than to the rear surface 10b thereof.

Thus, as the slats 11 hinge together along the respective edges 11a and 11b thereof in order to move from the second accordion-shaped configuration to the third flat configuration, the protruding rib 44 increasingly compresses the first flexible seal 43 in its groove 45 as said slats 11 pivot to make the device 1 fluid-tight by forming a low-pressure seal.

It should be noted that not all of the first transverse seals disposed between two consecutive slats will necessarily be progressively compressed as the slats move from the second position to the third lowered sealing position. More specifically, because of the bulging belly shape of the slats subjected to the frontal force, the pressure exerted on some of the first seals will gradually be relieved as the slats pivot, without any loss of watertightness, as they will already have been stressed in the second position.

Similarly, according to this alternative aspect in FIG. 7, the second high-pressure, longitudinal, passive sealing means 50 includes, on a front face 53f of the hinge hook 53 of a given first slat 11, a transverse recess 55 enclosing a second flexible transverse seal 52 cooperating with the rear face 11d of the front part 10f of a second slat 11 below the given first slat 11. These elements are positioned closer to the front surface 10f of the closure apron 10 than to the rear surface 10b thereof.

Thus, the greater the force F (rise of water over several tens of centimetres to more than a metre, depending on the width of the slats 11 of device 1—force of the wind during a strong storm—individual using force or a battering ram) exerted on the front face 10f of the closure apron 10, the more the rear face 11d compresses the second flexible transverse seal 52 inside its transverse groove 53 so as to compress it progressively as the slats 11 move from the second accordion-shaped configuration to the third flat configuration in order to make the device 1 fluid-tight, resistant to storms and able to withstand any intrusion attempts.

Similarly, not all second transverse seals disposed between two consecutive slats in these two aspects will necessarily be progressively compressed as the slats move from the second position to the third lowered sealing position. More specifically, because of the bulging belly shape of the slats subjected to the frontal force, the pressure exerted on some of the second seals will gradually be relieved as the slats pivot, without any loss of watertightness, as they will already have been stressed in the second position.

In the cases shown, the first flexible transverse seal 43 and the second flexible transverse seal 52 are made of silicone (of the staminalene type) or EPDM, are preferably fire-resistant, and are both in the form of a strip with a polygonal, circular or preferably oval cross-section. The seals can also be hollow to reduce the weight of the apron and improve their compressibility, thus improving high and low pressure seals.

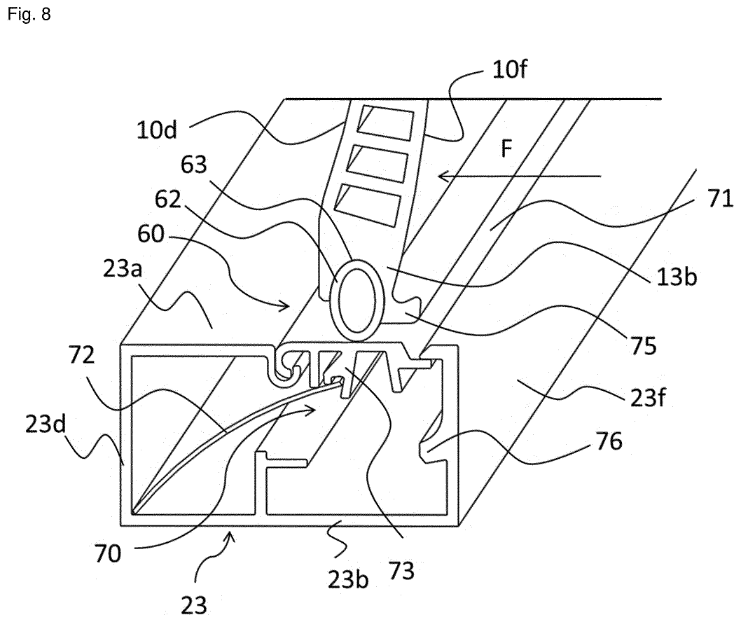

As shown in FIG. 8, the device 1 includes, at the bottom slat 13, a third longitudinal means 60 for creating a passive, low-pressure, lower seal, and a movable covering 70.

More specifically, this third longitudinal means 60 for creating a passive, low-pressure, lower seal includes a third flexible transverse seal 62, for example made of staminalene-type silicone for its resistance to cyclic mechanical loading and temperature, housed in a transverse groove 63 in the lower longitudinal edge 13b of the bottom end slat 13.

The movable dust covering 70 is used to prevent foreign bodies from entering the lower channel 23 when the shutter 1 is raised, to guide the bottom slat 13 more easily into its recess and to prevent the bottom slat 13 from coming away (unintentional raising of the apron) when the water level rises. This covering 70 includes an upper closure cover 71 hinged to an upper wall 23a of the lower channel 23, a leaf spring 72 bearing on the one hand against a lower groove 73 in the upper closure cover 71 and on the other hand inside the lower channel 23, for example at the junction angle of its rear wall 23d and bottom wall 23b, a hook 75 provided on the front face 10f of the bottom slat 23, and an internal hook 76 rigidly connected to the front wall 23f of the lower channel 23.

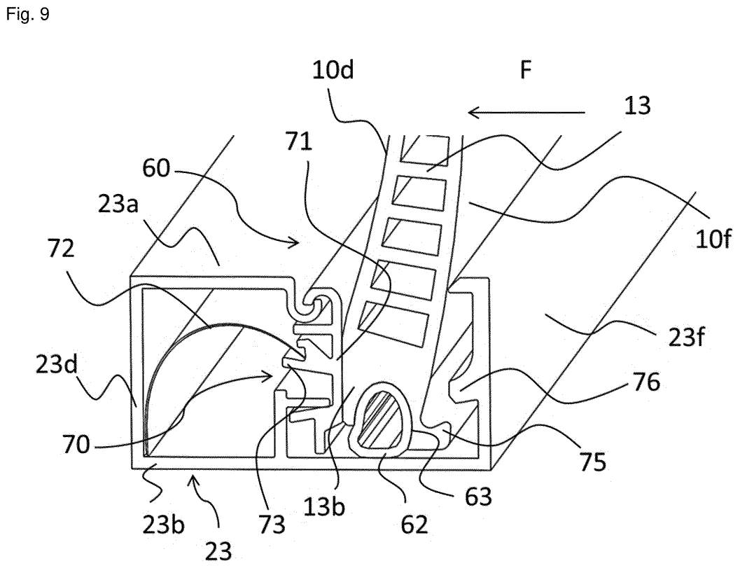

In the second position of the closure apron 10 (FIG. 8), the third flexible transverse seal 62 bears against the closure cover 71 to create a low-pressure, passive seal. When a force F is applied to the front face 10f of the closure apron 10, the slats 11 pivot longitudinally relative to one another along their respective upper edges 11a and lower edges 11b, causing the bottom slat 13 to move towards the lower channel 23. This displacement is accompanied by a vertical downward thrust of the bottom slat 13 onto the closure cover 71 via the third flexible transverse seal 62, which has the effect of pivoting said cover 71 against the elastic return force of the leaf spring 72, as illustrated in FIG. 9.

When the closure apron 10 has reached the third, lowered position, the third transverse flexible seal 62 bears against the bottom wall 23b of the lower channel 23, creating a fluid-tight seal (FIG. 9).

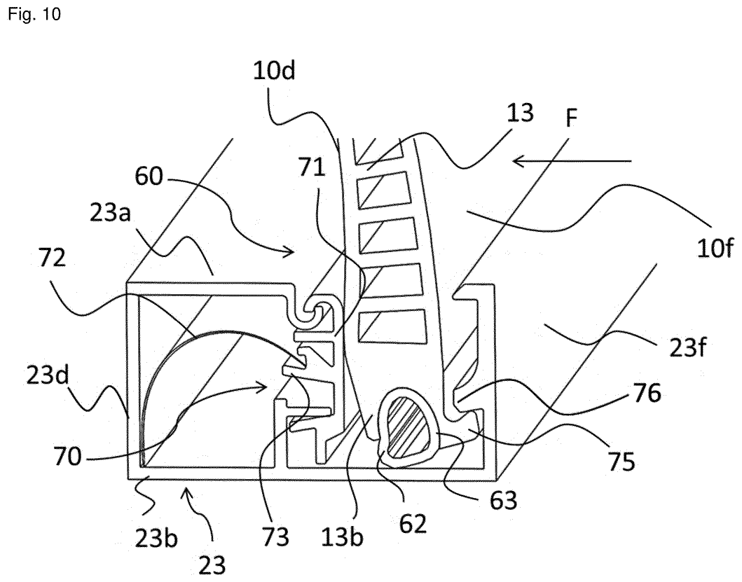

Continuing this movement as shown in FIG. 10, the bottom slat 13 pivots slightly so that its hook 75 engages with the hook 76 of the lower channel 23.

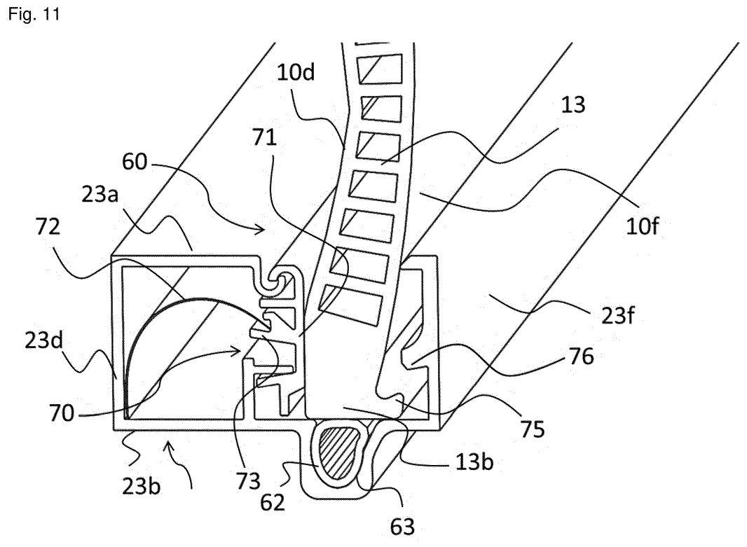

According to an alternative aspect illustrated in FIG. 11, the third flexible transverse seal 62 is housed in a transverse groove 63 formed directly in the bottom wall 23b of the lower channel 23 in the form of a protrusion. This flexible transverse seal 62 protrudes upwards from the groove 63 so that, when the closure apron 10 is in the third lowered sealing position, said third transverse seal 62 is compressed between the lower longitudinal edge 13b of the bottom slat 13 and said bottom wall 23b of the lower channel 23 in order to seal the device 1 against said fluid.

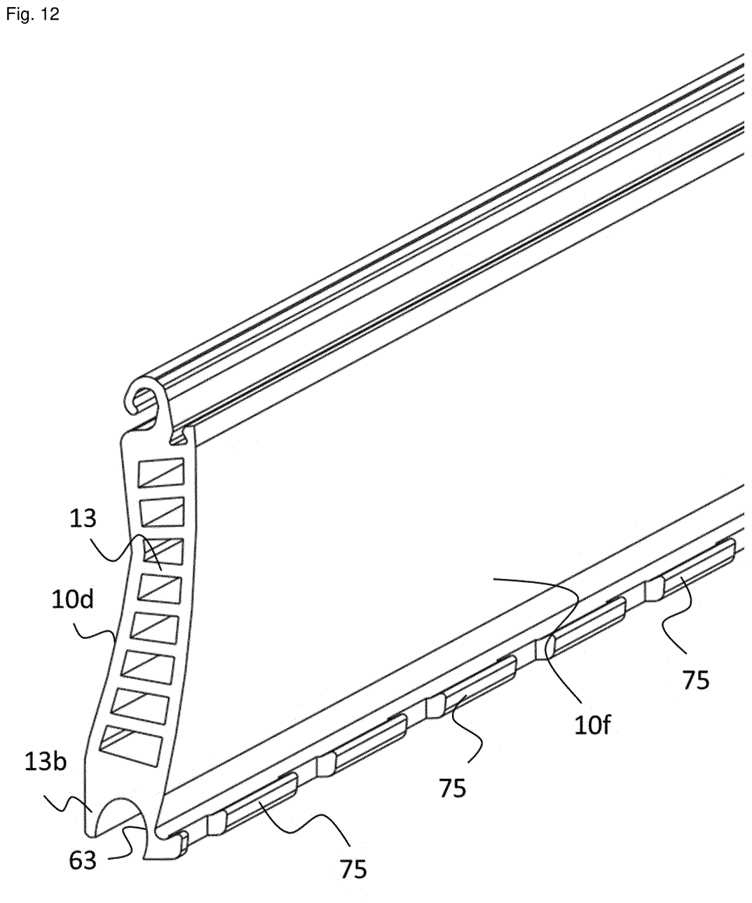

FIG. 12 illustrates an alternative aspect wherein the hook 75 of the bottom slat 13 is discontinuous, i.e. made up of a multitude of small, independent hooks 75 spaced longitudinally apart from one another. In this a priori weight-saving configuration, it may be advantageous to reinforce the hooks 75 close to the centre of the closure apron 10, because it is at this point that the frontal pressure force F is likely to be the highest on the closure apron 10 and thus deform the slats 10 more intensely. As a result, there is less of a risk of the hooks 75 disengaging at this point, improving the lower sealing of the device.

Once the hook 75 of the bottom slat 13 is disengaged from the hook 76 of the lower channel 23, the elasticity of the leaf spring 72 allows said bottom slat 23 to be raised and the closure cover 71 to pivot in the opposite direction so as to return the movable covering 70 to its position in which it closes off the lower channel 23 (FIG. 8).

It could also be advantageous to provide the front wall 23f of the lower channel 23 (above the hook 75 for example) with a fourth lower, longitudinal seal which would be compressed when the bottom slat 13 is pivoted with the closure apron 10 in the third position (transition from FIG. 9 to FIG. 10). According to a structure inversion, it is the bottom slat 13 which could include this fourth lower, longitudinal seal on the front face 10f of the closure apron 10. This fourth transverse seal could also be positioned on the rear face 10d of the bottom slat 13 and bear against the surface of the cover 71 in the position illustrated in FIG. 10.

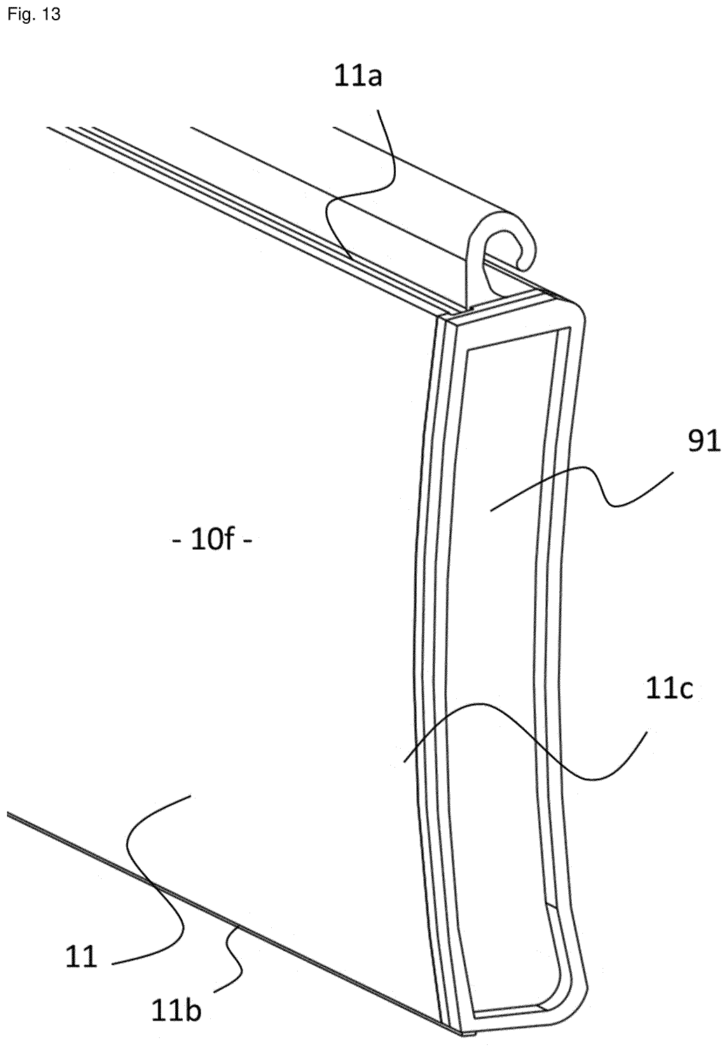

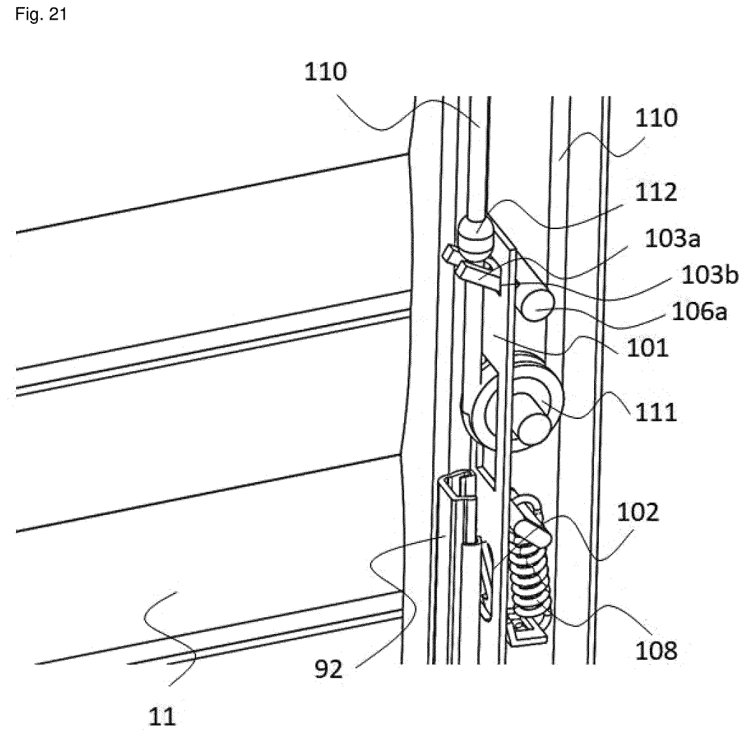

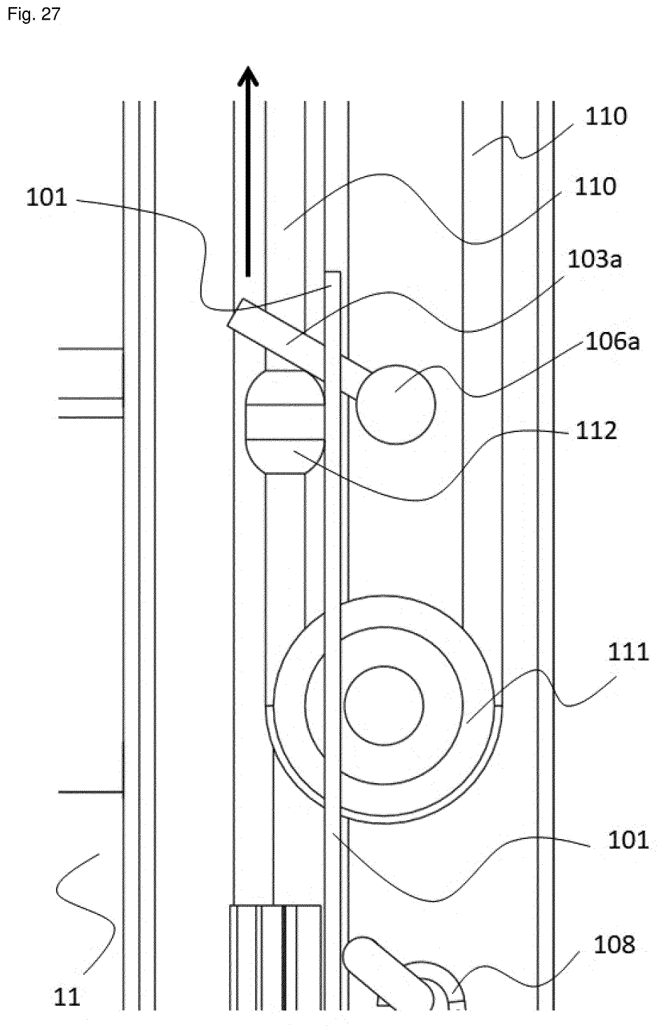

As illustrated in FIGS. 13 to 49, the device 1 is also provided with a fifth lateral sealing means 90 housed in each of the two lateral slides 22.

The main purpose of this fifth lateral sealing means 90 is to prevent water from infiltrating on either side of the closure apron 10, and thus into the protected building, in an area that is particularly sensitive in terms of sealing.

The system used for this purpose has been designed on the one hand to guarantee this seal in the event of a low water pressure, but also in the event of a high to very high water pressure (several tens of centimetres of water, or even more than a metre of water, pressing on the front face 10f of the closure apron 10), in a simple, preferably automated way and without the need for an additional energy source, so that it can operate completely independently when the building's occupants are not present. The proposed solution also helps to prevent lateral air infiltration in the event of strong gusts of wind.

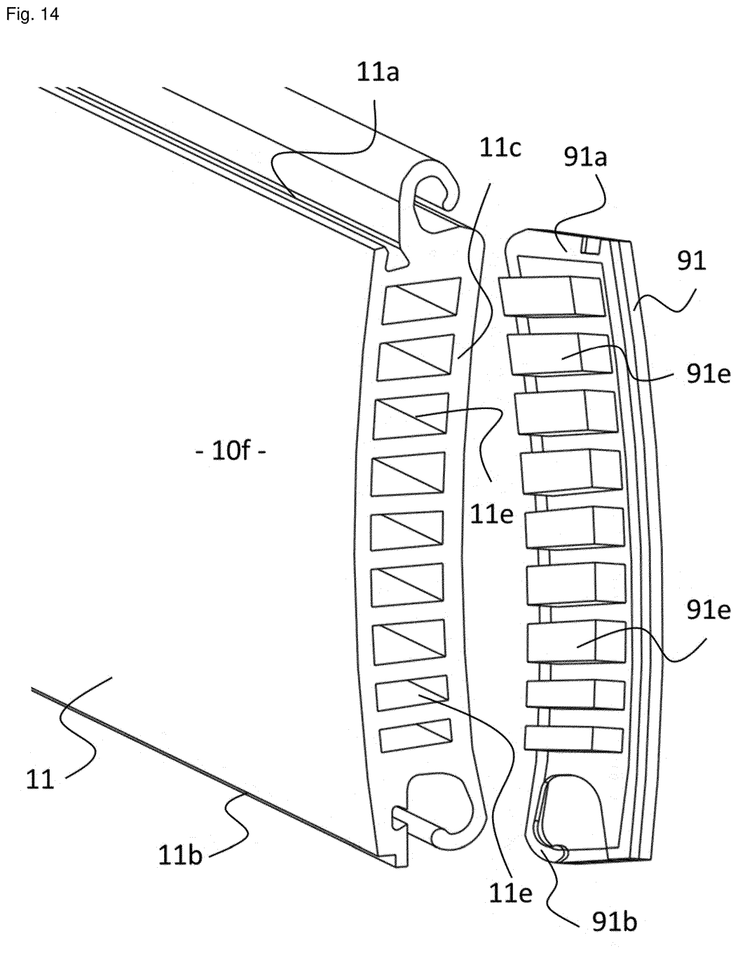

More specifically, as illustrated firstly in FIGS. 13 and 14, the fifth lateral sealing means 90 includes a stopper seal 91 made of injected silicone provided with protrusions 91e which are inserted into recesses 11e in the two lateral ends 11c of each of the slats 11. These injected silicone seals 91 are mounted when the device 1 is installed and remain rigidly connected to the slats 11 (for example by bonding, press-fitting or any other watertight mechanical connection).

The upper part 91a and lower part 91b of each stopper seal 91 are also adapted to the particular rounded shapes of the curved parts of the upper edge 11a and lower edge 11b of said slats 11 to improve sealing over the entire height of the given slat 11.

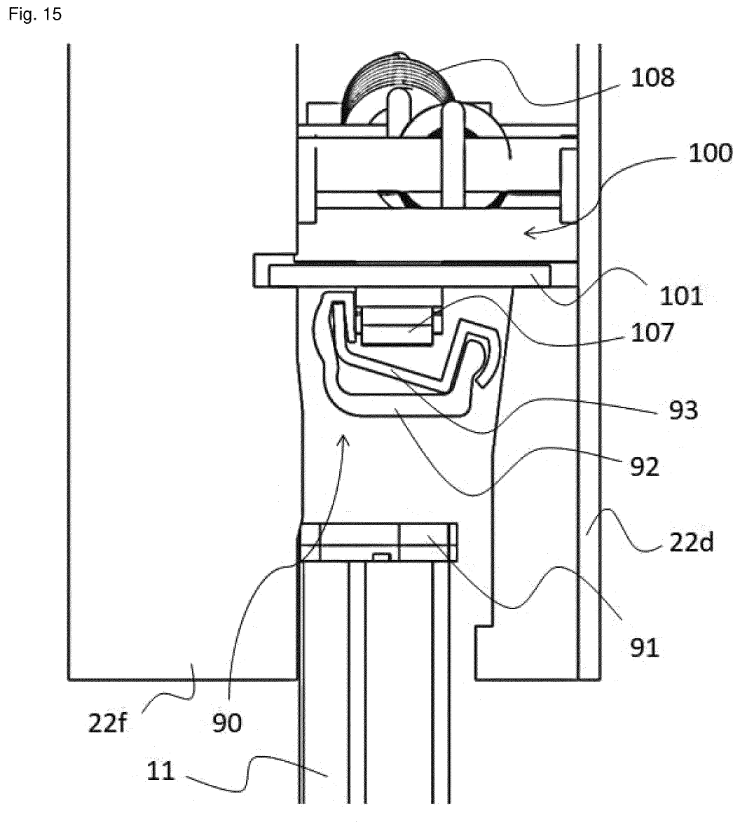

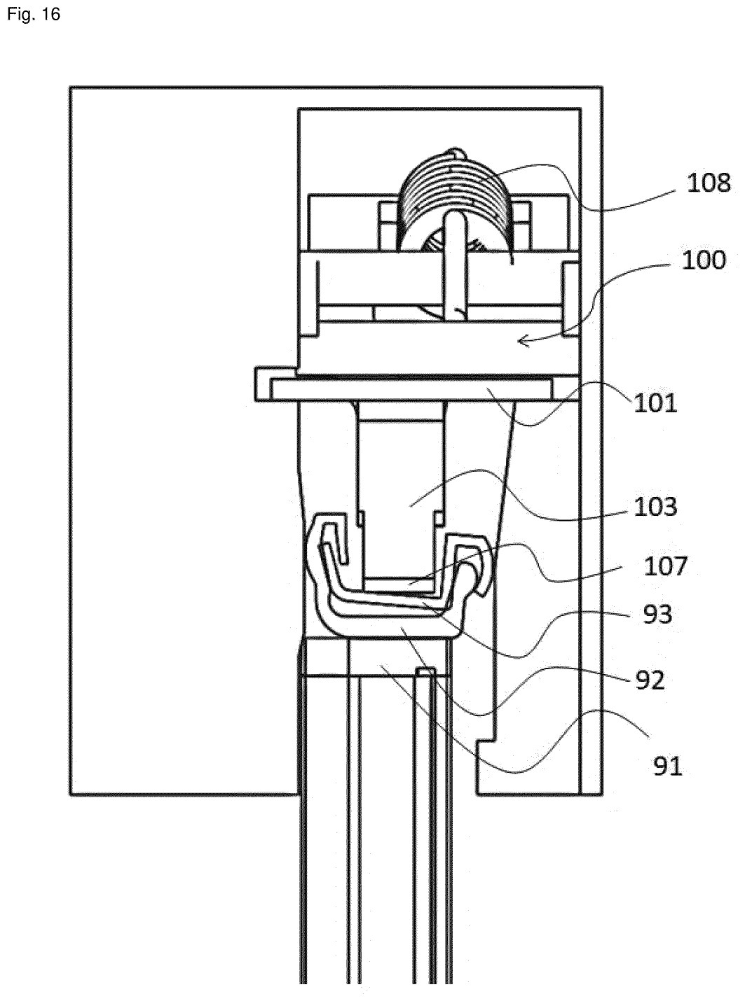

As can be seen in the partial, sectional views in FIGS. 15 and 16, the fifth lateral sealing means 90 further includes a U-shaped vertical seal 92 (when viewed from above), for example made of injected silicone, against which a “floating” vertical clamping bar 93, typically made of aluminium, can bear. The U-shaped vertical seal 92 and the vertical clamping bar 93 are capable of moving laterally in horizontal translation inside the lateral slides 22 by a few millimetres to a few centimetres so as to be able to move towards the lateral ends 11c of the slats 11 (to create the lateral seal) or, on the contrary, move away therefrom.

Once the closure apron 10 has been lowered, there will be a phase for activating the clamping mechanisms which will cause the thin clamping blade 93 to move. If necessary, this blade will also be able to conform to the movement of the slats 11 as the water rises, so that the seals 91 and 92 flexibly compensate for the horizontal offset which may occur between the slats 11 under the frontal pressure exerted on the closure apron 10.

More specifically, the U-shaped vertical seal 92 and the vertical clamping bar 93 can be pressed together against the stopper seal 91 and against the front wall 22f and rear wall 22d of each slide 22 using a pressing member 100, the design whereof will be described in numerous alternative aspects hereinbelow and which does not require electricity (in almost all aspects).

This system thus makes it possible to plug the end 11c of the slats 11 (particularly at the front-on the water side) using the stopper seals 91, but also to block the passage of water at the front and at the rear of each slide 22, due in particular to the U-shape of the vertical seal 92 which is clamped by deformation against the front 22f and rear 22d vertical walls/fins of the lateral slides 22.

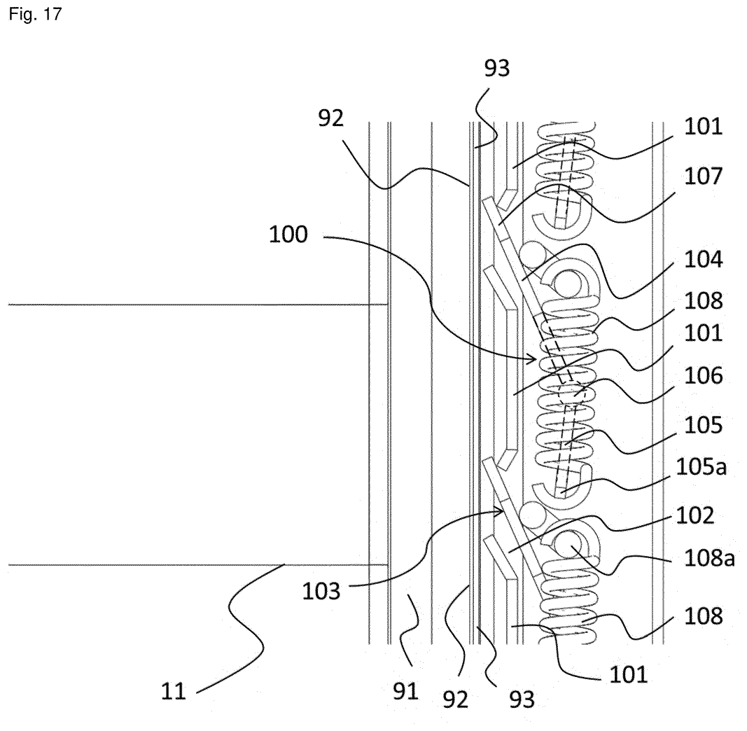

According to a first aspect illustrated in particular by FIGS. 17 to 33, the pressing member 100 of the fifth lateral sealing means 90 includes a lateral activation bar 101 capable of sliding vertically in the space between the lateral ends 11c of the slats 11 and the bottom wall 22a of the lateral slides 22. The lateral activation bar 101 typically extends substantially over all or part of the height of the device 1, preferably at least over two thirds or even three quarters of the height of the closure apron 10 from the ground upwards as this is the area the most subject to flooding, and has a series of vertically-aligned apertures 102 spaced apart from one another. This lateral activation bar 101 can only move vertically from top to bottom and from bottom to top to cause the assembly consisting of the vertical clamping bar 93 and the U-shaped vertical seal 92 to move in a horizontal linear manner towards the stopper seal 91.

To this end, as illustrated in FIGS. 17 to 19, the pressing member 100 includes a pivoting bistable lever 103 provided with two arms 104 and 105 connected to one another at a horizontal hinge pin 106 extending as a whole between the vertical fins 22f and 22d of each lateral slide 22. A bistable lever 103 of this type corresponds to each aperture 102 in a lateral activation bar 101, each lever 103 thus being placed substantially facing one end 11c of a given slat 11/stopper seal 91.

Each arm 104 of a lever 103 also carries a pressure shoe 107 (which can simply consist of the end of the arm 104) located facing the vertical clamping bar 93, which is also facing a lateral end 11c of a slat 11/stopper seal 91.

Finally, each lower arm 105 of a lever 103 is connected, at its free end 105a, to an extension spring 108 which allows the pressing member 100 to operate in a bistable manner, said spring also being hooked to an unmoving upper pin 108a for the tensioning thereof.

Thus, when the lateral activation bar 101 is in the upper inactivation position (FIG. 17), the upper arm 104 of the bistable lever 103 is raised as far as it can go and the pressure shoe 107 is distant from the vertical clamping bar 93 so that the vertical U-shaped seal 92 is not compressed against the stopper seal 91 of each slat 11. In this position, no lateral seal is created at the lateral slides 22 and the lateral ends 11c of the slats 11.

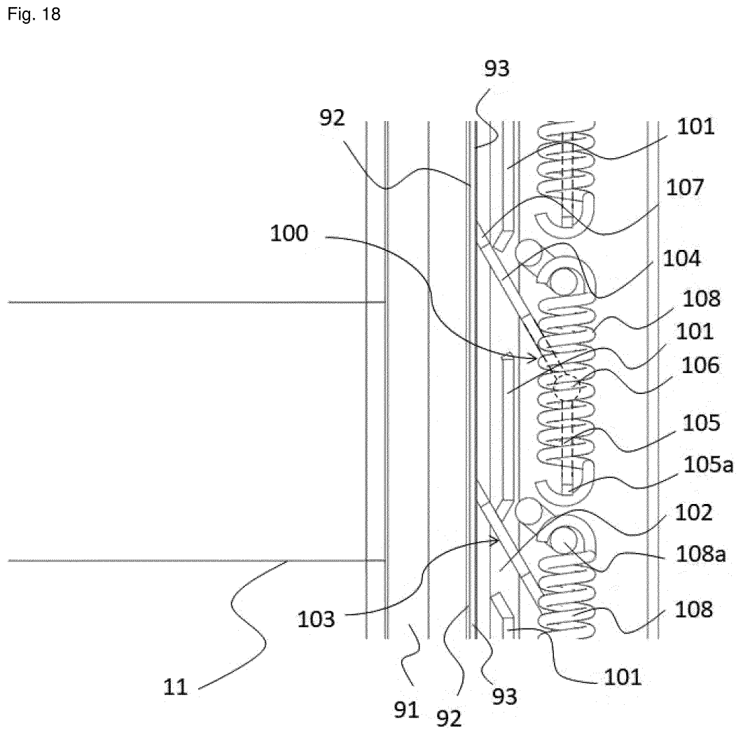

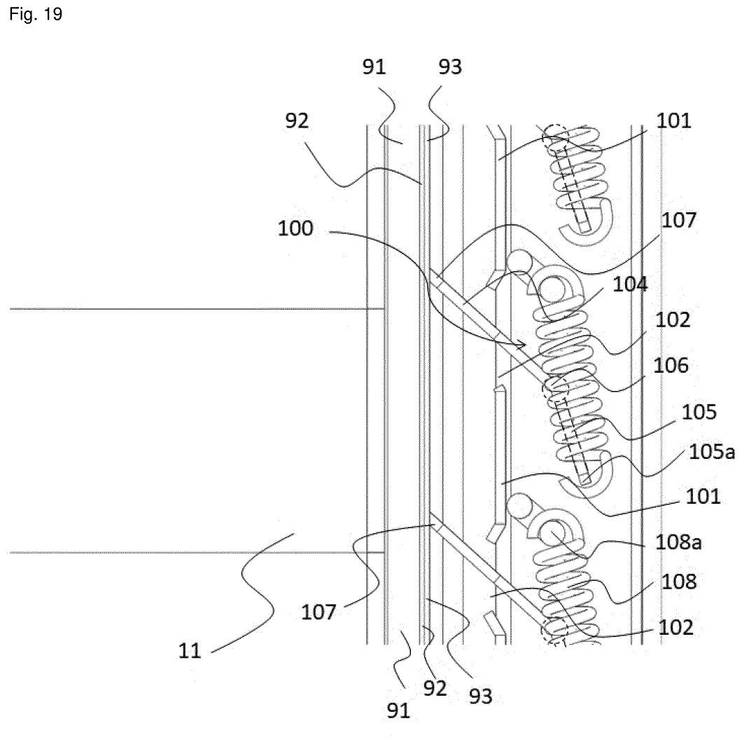

When the lateral activation bar 101 starts to move downwards (FIG. 18) inside the lateral slide 22, its apertures 102 cause the bistable lever 103 to pivot about the pivot pin 106 so that the upper arm 104 gradually clamps the pressure shoe 107 against the vertical clamping bar 93 which, in turn, compresses the U-shaped lateral seal 92 against the stopper seal 91 of each slat 11 and against the front 22f and rear 2d vertical fins of the lateral slides 22. This movement is repeated simultaneously for all of the pivoting bistable levers 103 of the two lateral pressing members 100 so that the lateral seal is created along the entire length of the closure apron 10, as shown in FIG. 19.

To summarise, the vertical downward linear displacement of the two lateral activation bars 101 causes the simultaneous pivoting of all of the bistable levers 103, which jointly bear on each of the two vertical clamping bars 93 located on either side of the slats 11 inside the lateral slides 22, thus causing the U-shaped lateral seals 92 to compress against the stopper seals 91 of all of the slats 11 and against the front wall 22f and rear wall 22d of each lateral slide 22. It should be noted that a watertight seal can already be produced if the lateral seal 92 bears against only one of the front wall 22f or rear wall 22d of each lateral slide 22 (preferably the front wall 22f as the water comes from this area).

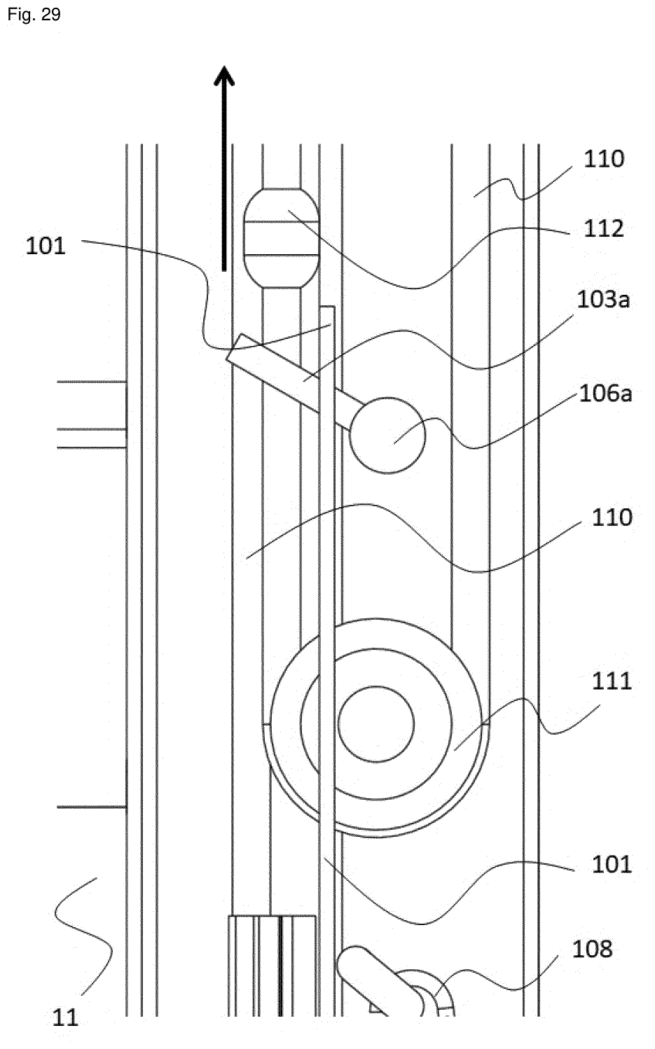

Once the bistable system has reached a tilting point (FIG. 29), the extension spring 108 maintains a sufficient pressure force to allow the U-shaped vertical seal 92 to permanently compress the stopper seal 91 and rest on the front wall 22f and rear wall 22d of each lateral slide 22 in order to maintain the lateral seal in the event of a storm or unforeseen water surge against the closure apron 10.

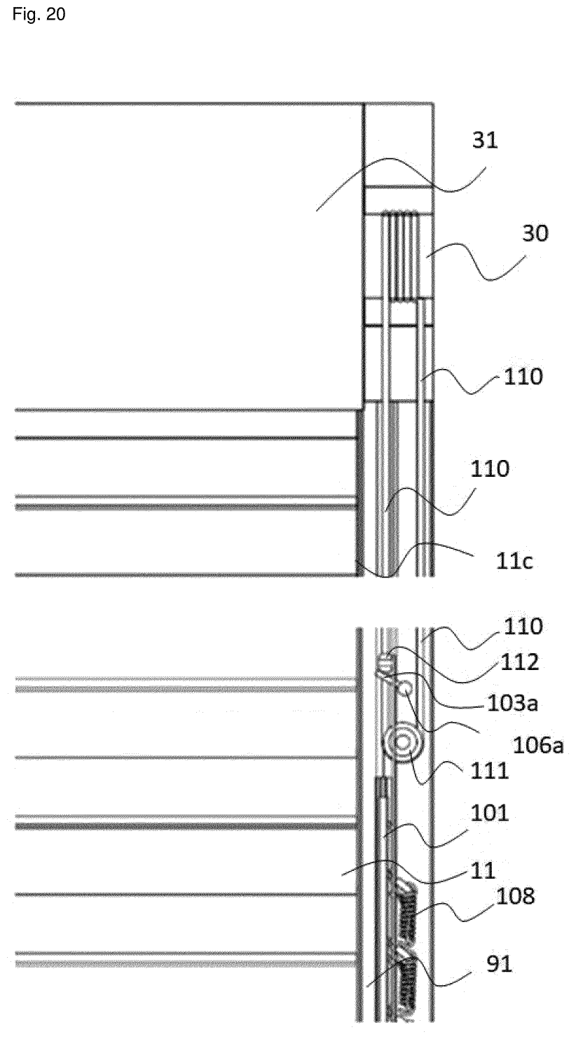

When this lateral seal must be removed, for example to raise the closure apron 10, each lateral activation bar 101 is raised vertically, causing the bistable levers 103 to pivot in the opposite direction of rotation until they reach the opposite tilting point about the pivot pin 106, where the extension spring 108 pulls on the lower arm 105 of the bistable lever 103 to move the pressure shoe 107 away from the vertical clamping bar 93 (return to FIGS. 18 and 20). The U-shaped vertical seal 92 then ceases to be compressed by the vertical clamping bar 93 against the stopper seal 91 of each slat 11 (return to FIG. 17) and the front wall 22f and rear wall 22d of each lateral slide 22.

In the present case, the vertical translational movement of the lateral activation bar 101 is controlled by a cable 110 connected directly to the rolling shaft 30 of the closure apron 10, as shown in FIGS. 20 to 29.

More specifically, the cable 110 is connected to a tension roller 111 and carries a pin 112 (or weight) crimped onto said cable close to said roller 111. A hinged lever 103a, for example in the form of a finger with two branches, is connected on the one hand inside an opening 103b in the upper end of the lateral activation bar 101 and on the other hand to an unmoving pivot 106a about which it can rotate by means of said pin 112.

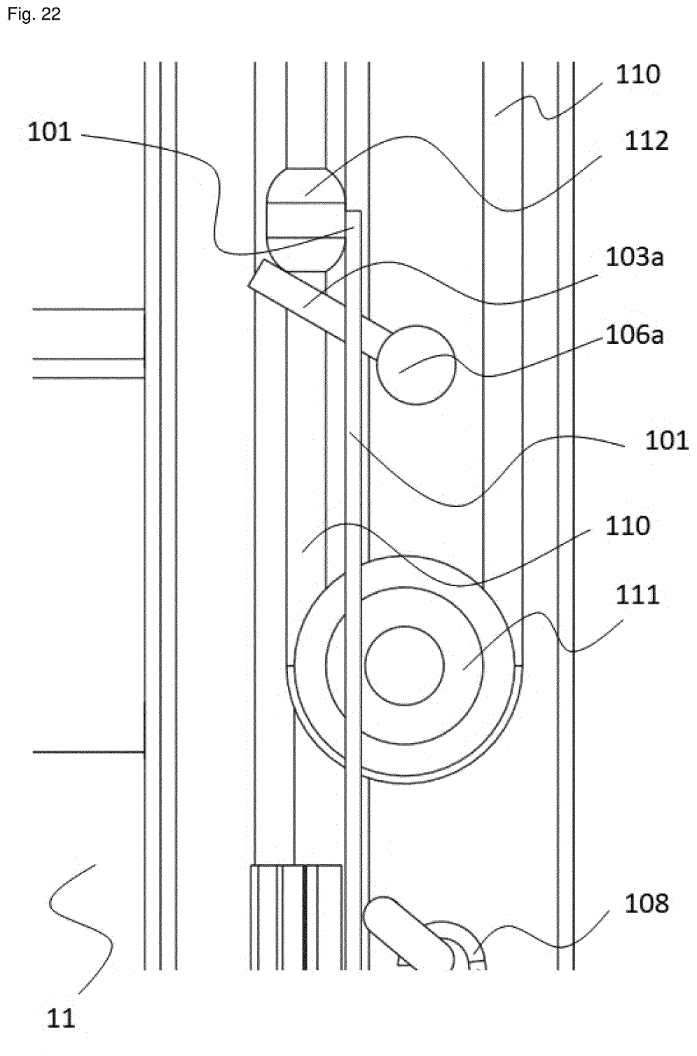

Thus, in the upper inactive position of the lateral activation bar 101, the lever 103a is inclined upwards in the position illustrated in FIG. 22, with the pin 112 positioned above it, and the vertical U-shaped seal 92 is not in contact with the stopper seal 91 so that no lateral seal is created.

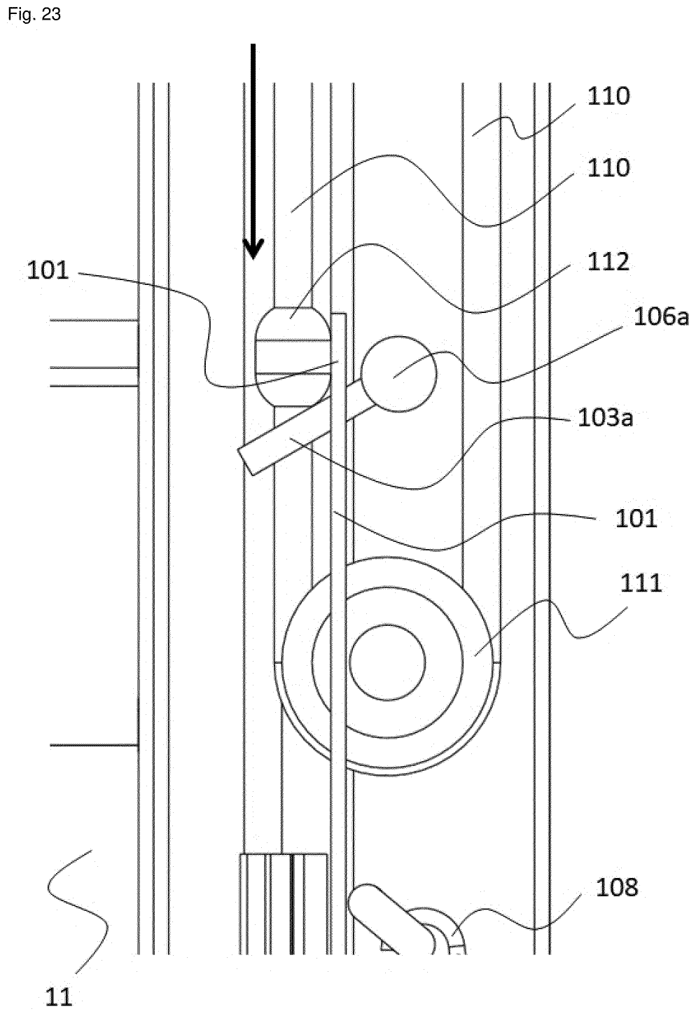

When the drive shaft 30 rotates in a given direction (that used to lower the closure apron 10), the cable 110 drives the pin 112 downwards according to the direction arrow shown, which pin 112 then causes the lever 103a to pivot about its pivot pin 106a to gradually lower the lateral activation bar 101 vertically, as illustrated in FIG. 23, which has the effect of causing the pressure shoe 107 to advance against the vertical clamping bar 93 so that the U-shaped vertical seal 92 progressively approaches the stopper seal 91 in order to create the desired lateral seal.

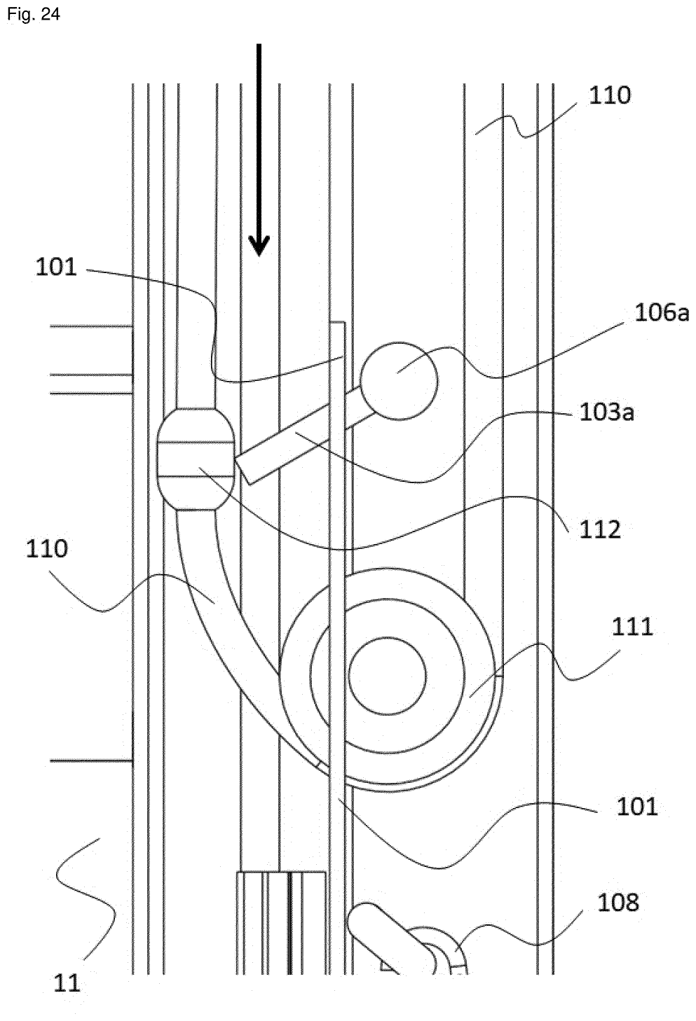

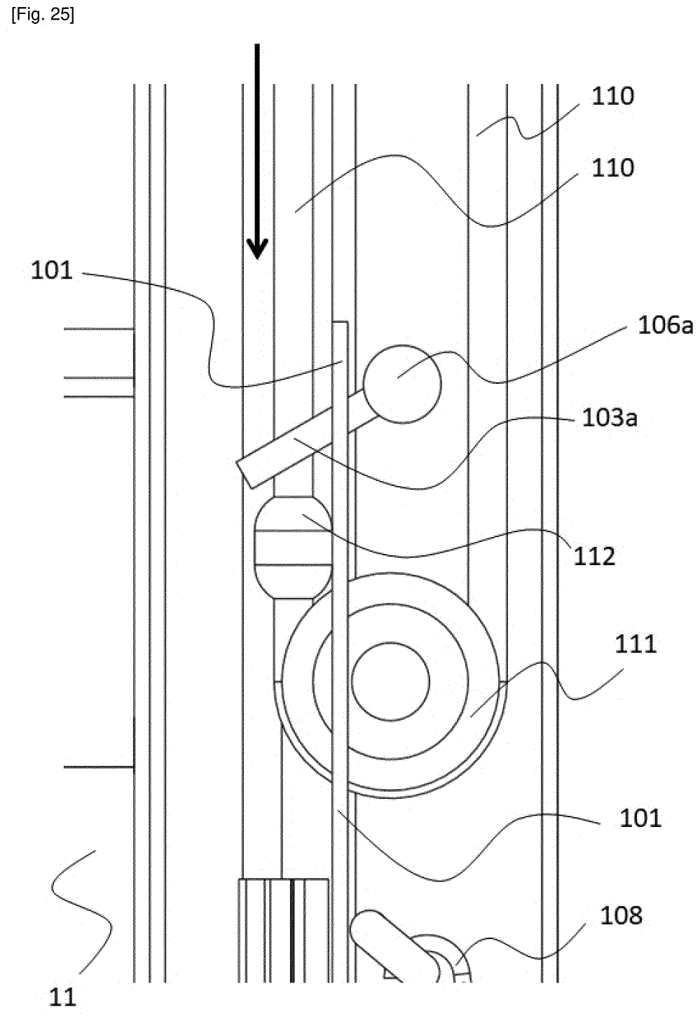

The cable 110 continues to rotate in the same direction, as illustrated in FIGS. 24 and 25, so that the pin 112 protrudes beyond the lever 103a (FIG. 24) and then passes thereunder (FIG. 25). In this position, the return spring 108 produces the force required to permanently clamp the pressure shoe 107 against the vertical clamping bar 93, which then maintains the compression of the U-shaped vertical seal 92 against the stopper seal 91 and against the front wall 22f and rear wall 22d of each lateral slide 22. The lateral seal of the closure apron 10 is thus ensured and maintained.

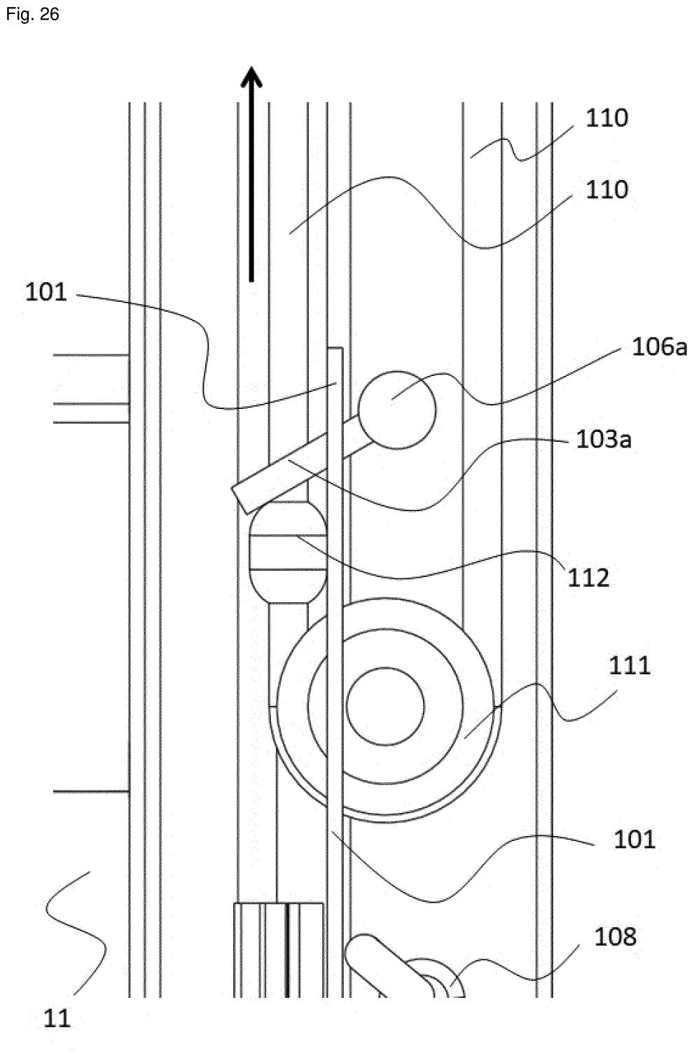

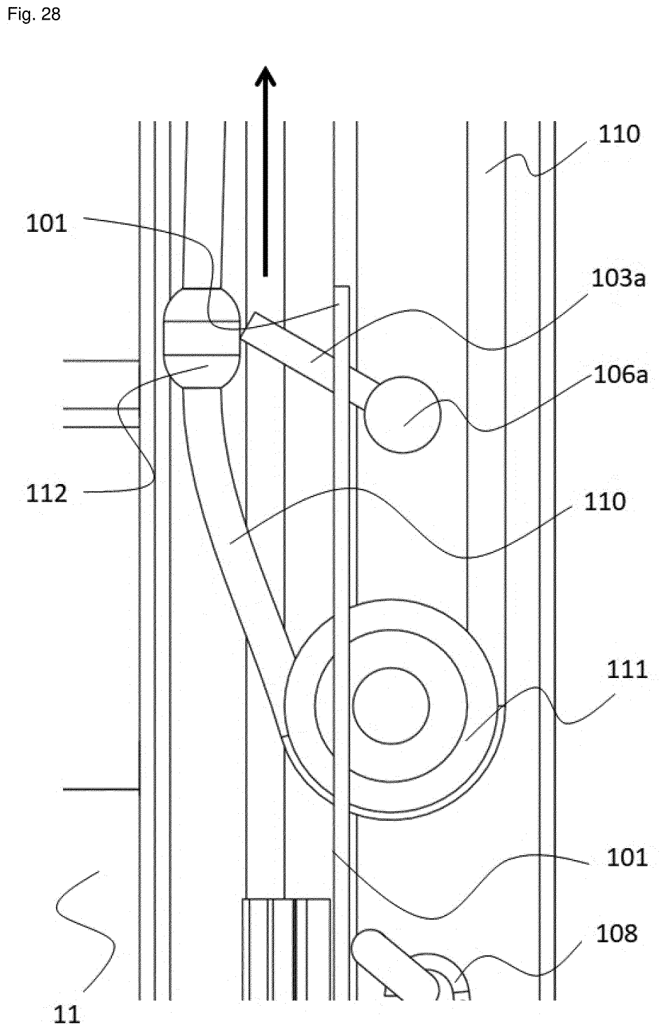

Conversely, FIGS. 26 to 29 illustrate the rotation, in the opposite direction, of the cable 110 and the rise of the pin 112 associated with this movement. The pin 112 thus comes into contact with the underside of the rectilinear lever 103a (FIG. 26), raises said lever 103a to cause it to pivot in the opposite direction about the pivot pin 106a (FIG. 26 then 27) so as to cause the lateral activation bar 101 to slide upwards, which has the effect of causing the arm 105 of the bistable lever 103 to rise to the tipping point and then beyond, in order to move the pressure shoe 107 away from the vertical clamping bar 93 with the aid of the return spring 108. The U-shaped vertical seal 92 is thus distant from the stopper seal 91 and the lateral seal ceases to have any effect. Once the pin 112 has passed the lever 103a, the cable 110 continues to rotate in order to place the activation bar 101 in the highest position (FIGS. 28 and 29).

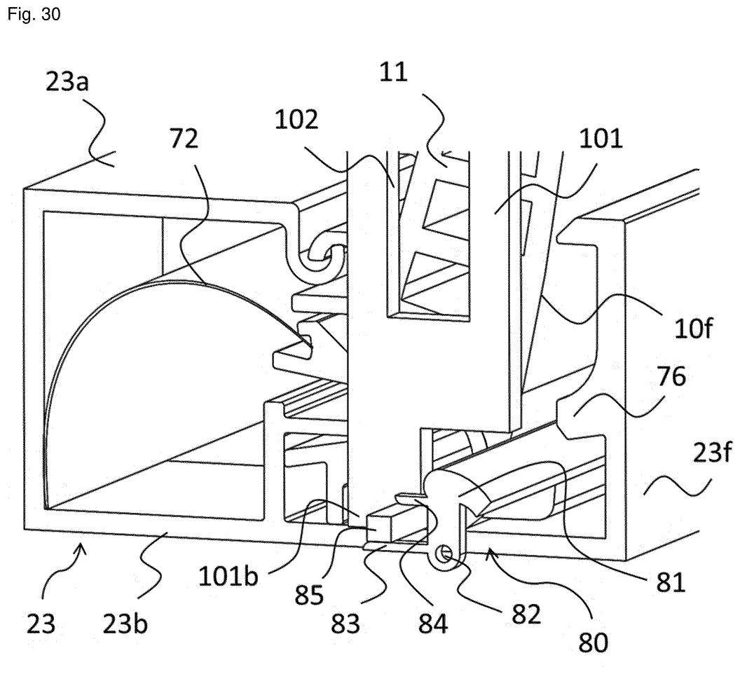

FIGS. 30 to 32 illustrate a latch 80 which can be used to lock the closure apron 10 in the lowered position directly using the activation bar 101. This latch 80 thus includes a main body 81 mounted so as to rotate about an unmoving pivot pin 82 and provided with two parallel fingers 83 and 84 capable of engaging with a transverse catch 85 connected to the activation bar 101.

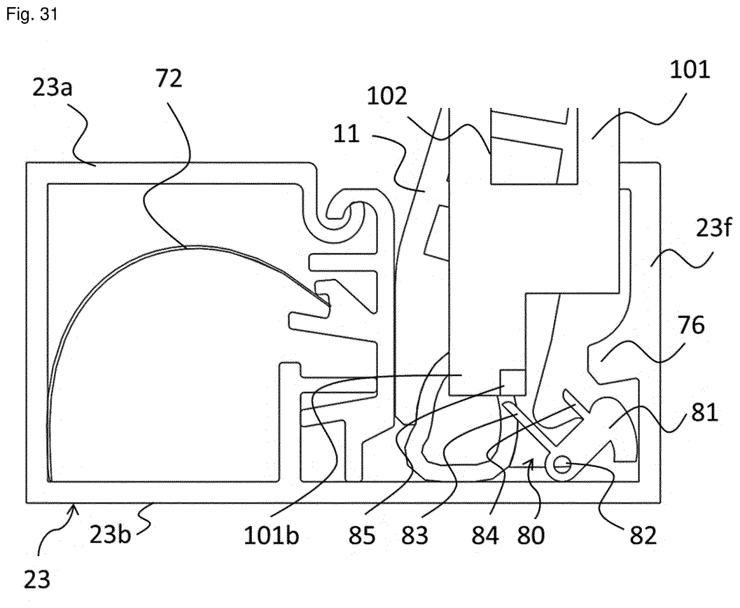

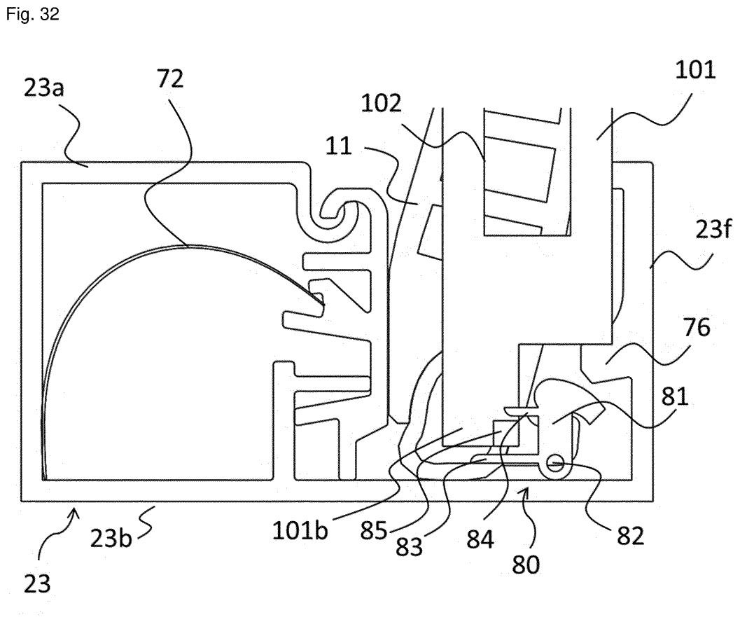

More specifically, as shown in FIGS. 31 and 32, when the activation bar 101 descends vertically, a lower part 101b thereof bears against the finger 83 and causes the body 81 of the latch 80 to pivot about the pivot pin 82 so that the catch 85 is trapped between the two fingers 83 and 84. When the activation bar 101 raises, the opposite effect occurs and the catch 85 is released from the two fingers 83 and 84 when the body of the latch 80 pivots in the opposite direction.

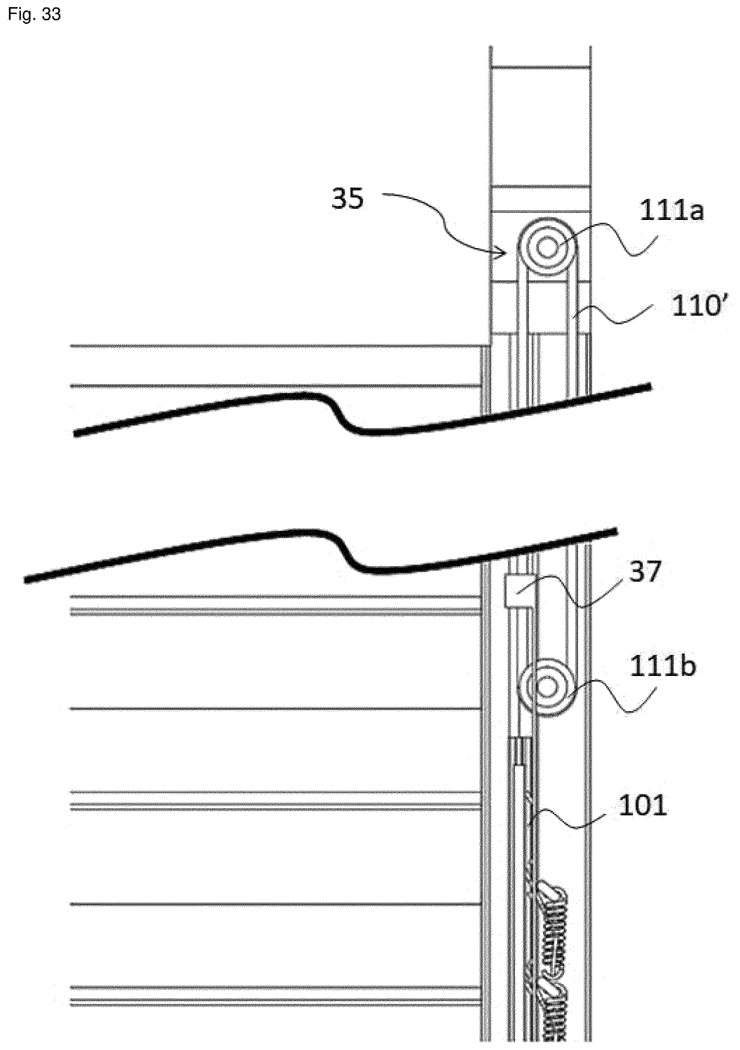

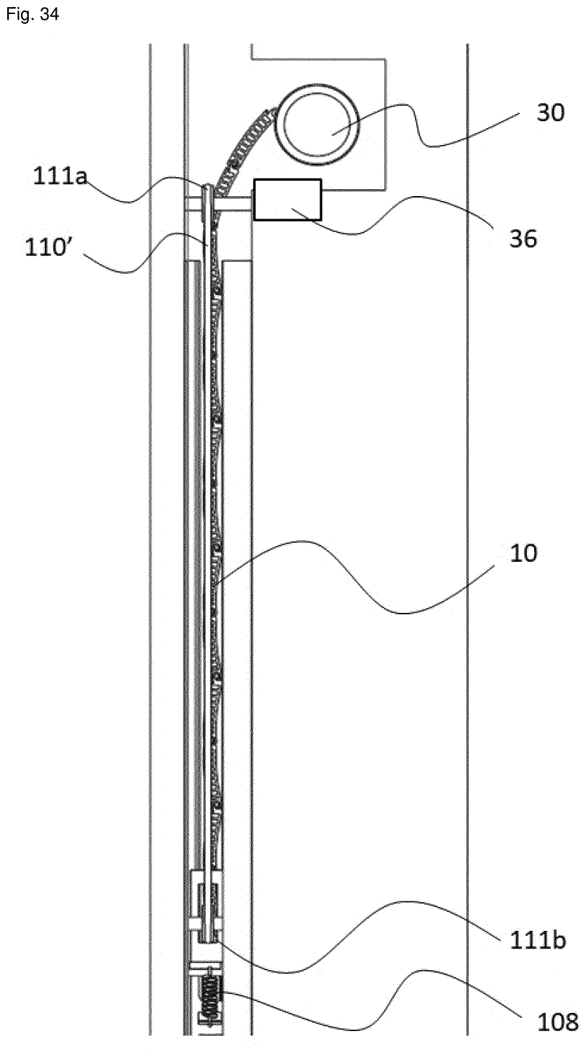

FIGS. 33 and 34 illustrate an alternative cable solution for vertically moving the lateral activation bar 101. In this alternative aspect, instead of using the shaft of the drive motor 30 for lowering/raising the closure apron 10 to move the lateral activation bar 101 vertically up and down, a second independent drive system 35 is provided in the upper casing 21. This second drive system 35 includes a stepper motor 36 and a cable 110′ mounted on upper and lower tension rollers 111a and 111b and provided with a connection 36 to the upper roller 111b and a connection 37 to the lateral activation bar 101. The stepper motor 35 thus rotates the upper roller 111b, which then drives the cable 110′, which in turn causes the lateral activation bar 101 to move vertically between the retreated position of the vertical clamping bar 93 and the advanced position thereof, enabling the U-shaped lateral seal 92 to be compressed against the stopper seal 91. Rotating the stepper motor 35 in the opposite direction causes the U-shaped lateral seal 92 to retreat from the stopper seal 91.

This solution with auxiliary motors 36 (one on each side) allows the lateral seal to be controlled independently of the rotation of the apron-rolling shaft, giving greater freedom of control. As the necessary stroke of the lateral activation bar 101 is short (in the order of 2 centimetres), half a turn of the roller 111a/111b will suffice. The diameter of the rollers 111a and 111b also limits the motor torque required for actuation. Finally, the cable 110′ always works under a tensile force, which avoids any risk of compression and thus of buckling instabilities.

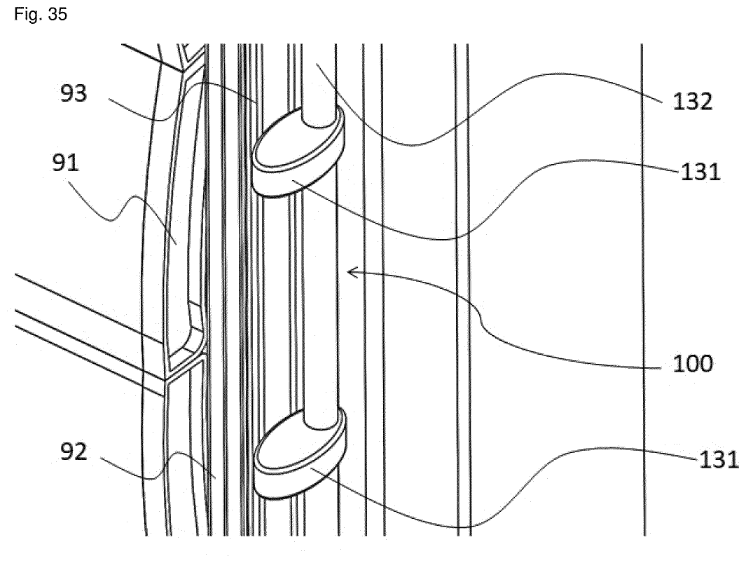

FIG. 35 provides a very diagrammatic illustration of a solution wherein the pressing member 100 consists of a series of lateral cams 131 stacked vertically in the lateral slides 22 on either side of the slats 11. These cams 131 are rigidly connected to a common vertical shaft 132 pivoting in one direction or the other (or only in one direction depending on the configuration) so as to act on the vertical clamping bar 93 to move the U-shaped vertical seal 92 towards or away from the stopper seal 91 in order to laterally seal or not seal the device. It goes without saying that means (not shown) are provided to hold the cams 131 in each of the positions, for example preloaded springs.

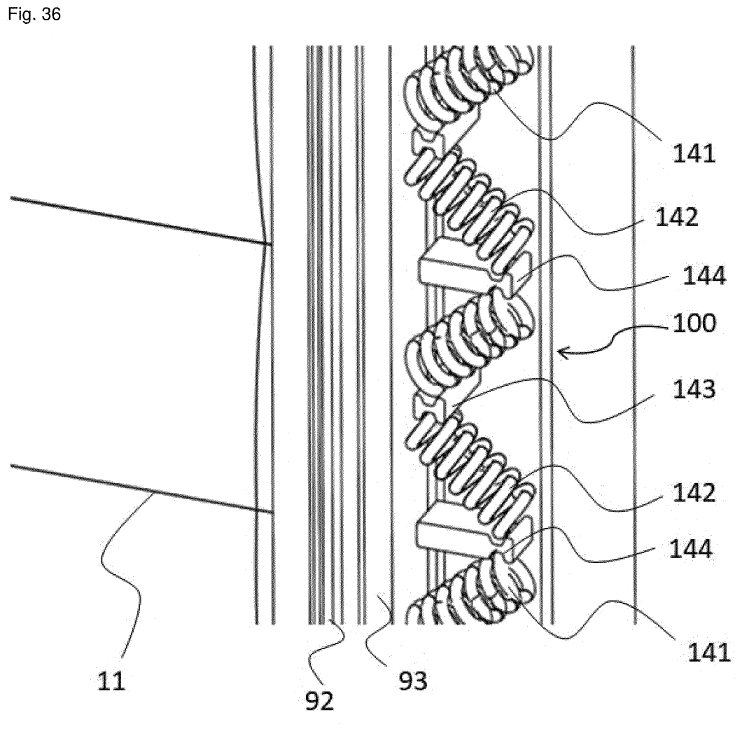

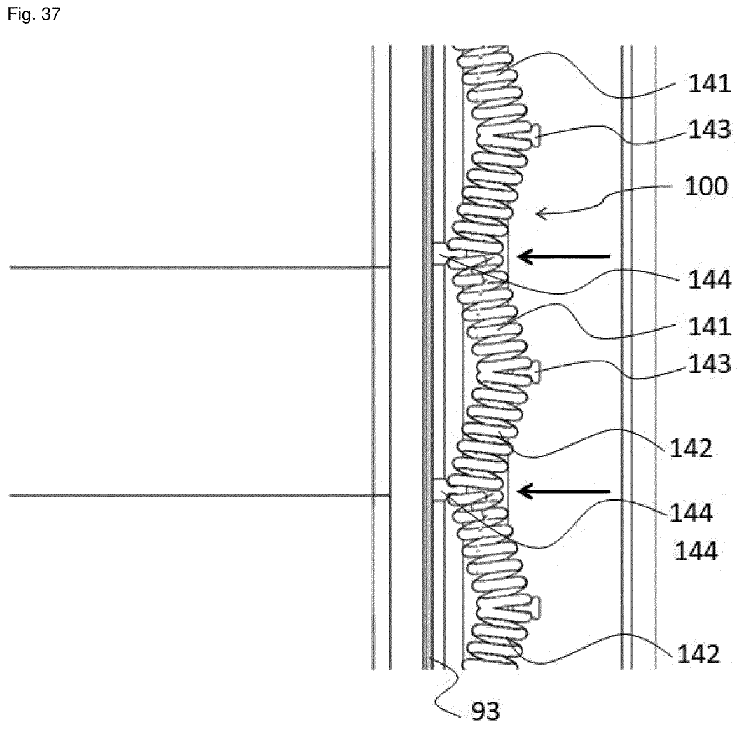

FIGS. 36 and 37 show a solution wherein the pressing member 100 includes a series of pairs of compression springs 141 and 142 stacked vertically in the lateral slides 22 on either side of the slats 11. These springs 141 and 142 are in a position of unstable equilibrium (a slight movement causes them to switch from one state to the other). For example, an upper spring 141 is rigidly connected to a first unmoving point 143 and to a transversally moving point 144, whereas a lower spring 142 is rigidly connected to a second unmoving point 143 and to said moving point 144. The transverse movement of the springs 141 and 142 by means of a wedge capable of horizontal translation allows the latter to bear against the vertical clamping bar 93 so that the U-shaped vertical seal 92 compresses the stopper seal 91 and bears against the front wall 22f and rear wall 22d of each lateral slide 22 to ensure the lateral seal, as illustrated in FIG. 37. It goes without saying that means are provided to hold the springs 141 and 142 in each of the two stable advanced/retreated positions.

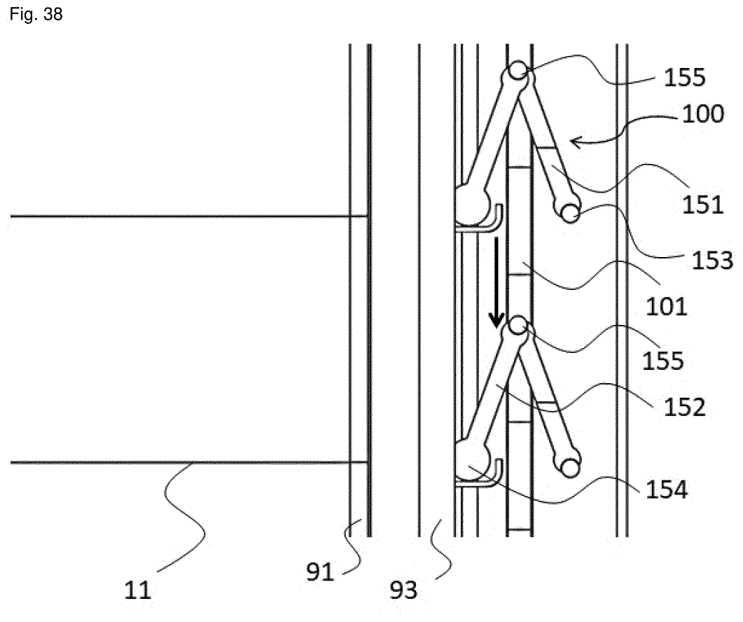

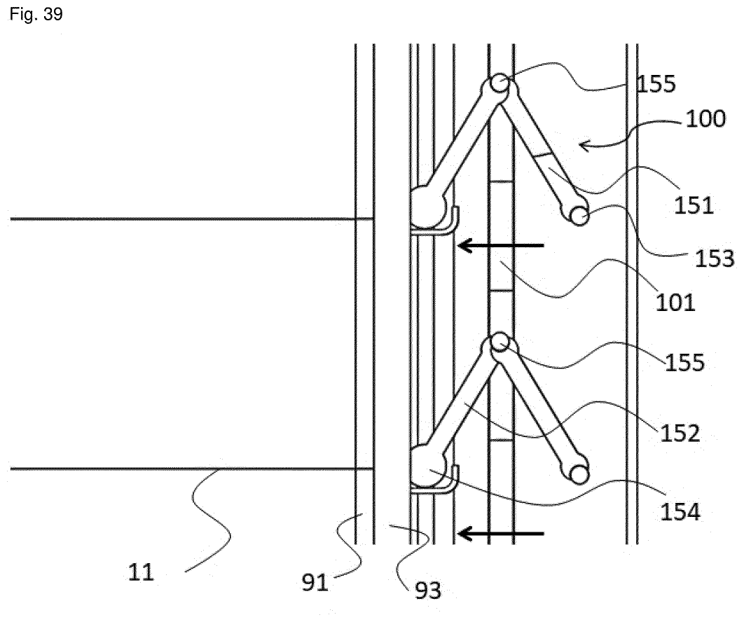

FIGS. 38 and 39 provide very diagrammatic illustrations of a solution wherein the pressing member 100 consists of a series of double pantographs 151 and 152 stacked vertically in the lateral slides 22 on either side of the slats 11. The pantographs 151 are connected to an unmoving rotation point 153 and to a vertically/transversally moving pivot 155 which is connected to the lateral activation bar 101, whereas the pantographs 152 are connected to the same vertically/transversally moving pivot 155 by means of the lateral activation bar and to a transversally moving support shoe shaft 154.

The vertical upwards and downwards movement of the activation bar 101 causes the pantographs 151 and 152 to pivot, which then push on the vertical clamping bar 93 so that the U-shaped vertical seal 92 compresses the stopper seal 91 and bears against the front wall 22f and rear wall 22d of each lateral slide 22 in order to ensure the lateral seal (FIG. 39). A reverse, upward movement of the activation bar 101 allows the springs 151 and 152 to return to their initial position (FIG. 37) and thus allows the U-shaped vertical seal 92 to be moved away from the stopper seal 91. It goes without saying that means are provided to hold the double pantographs 151 and 152 in each of the advanced/retreated positions.

It should be noted that in this aspect, when the lateral activation bar 101 descends to cause the pantographs 151 and 152 to extend by pivoting about the pivot pins 153 (unmoving pin) and 155 (moving pin), it also advances towards the slats 11 (see FIG. 39), whereas it retreats and rises as the pantographs 151 and 152 move closer together (FIG. 38).

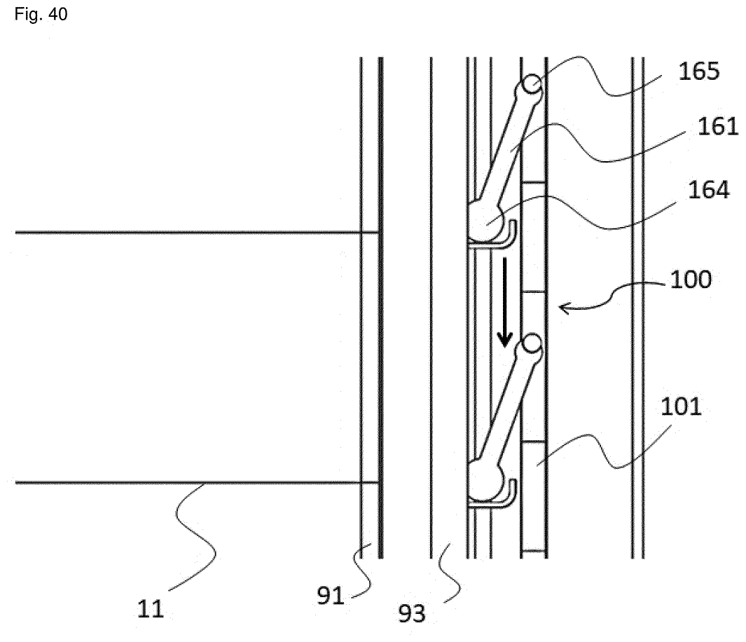

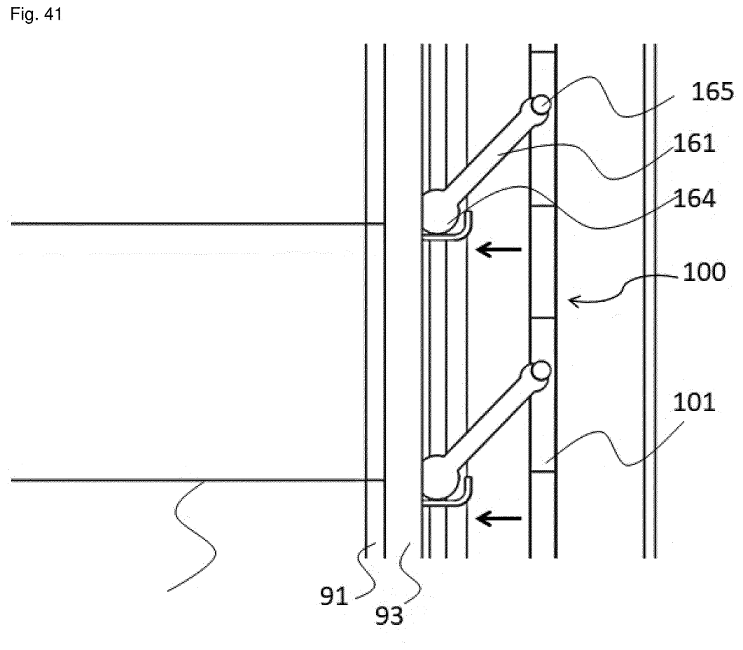

FIGS. 40 and 41 provide a very diagrammatic illustration of a solution wherein the pressing member 100 consists of a series of single pantographs 161 with deformable parallelograms stacked in the lateral slides 22 on either side of the slats 11 and used to move the vertical U-shaped seal 92 away from or towards the stopper seal 91 using a method similar to those described hereinabove (alternating transition from one position to the other to create/remove the lateral seal). The pantographs 161 are connected to a vertically movable pivot 165 which is coupled with the lateral activation bar 101, and with a transversally movable shaft 154.

The vertical upwards and downwards movement of the activation bar 101 causes the pantographs 161 to pivot, which then push on the vertical clamping bar 93 so that the U-shaped vertical seal 92 compresses the stopper seal 91 and bears against the front wall 22f and rear wall 22d of each lateral slide 22 in order to ensure the lateral seal (FIG. 41). A reverse, upward movement of the activation bar 101 allows the pantographs 161 to return to their initial position (FIG. 40) and thus allows the U-shaped vertical seal 92 to be moved away from the stopper seal 91. It goes without saying that means are provided to hold the pantographs 161 in each of the advanced/retreated positions.

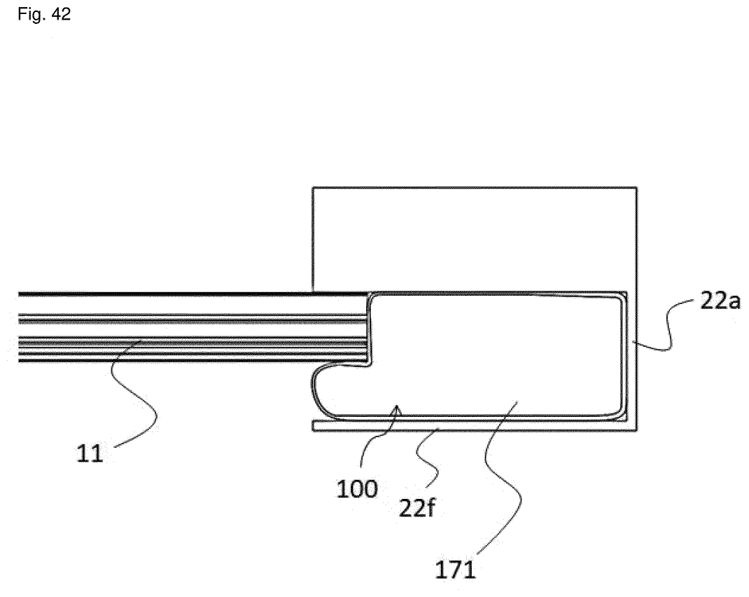

FIG. 42 provides a very diagrammatic illustration of a solution wherein the pressing member 100 consists of a reversible expansion joint 171 (change in volume) disposed between the front 22f, rear 22d and bottom 22a walls of each lateral slide 22, on either side of the slats 11, and used to move the vertical U-shaped seal 92 away from or towards the stopper seal 91 using a method similar to those described hereinabove (alternating transition from one position to the other to create/remove the lateral seal). These expansion joints 171 can be chemical, pneumatic or hydraulic expansion joints.

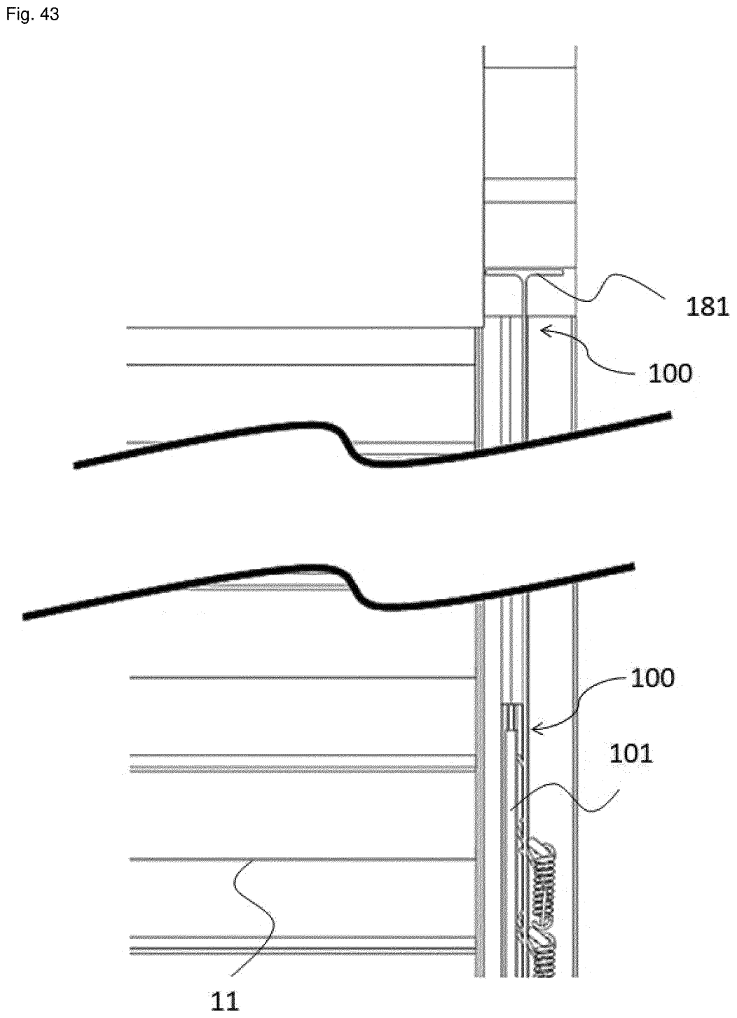

FIG. 43 provides a very diagrammatic illustration of a solution wherein the pressing member 100 consists of a bistable electromagnet 181 preferably disposed at the very top of the device 1, in the upper casing 21, and which acts directly on the vertical upwards and downwards linear movement of the lateral activation bar 101. The bistable characteristic of the electromagnet means that the same electromagnet can be used to activate and return the clamping member, the only limitation being that there must be a sufficiently high pushing force and return force to activate/return all of the stacked pressure systems, while at the same time having limited overall dimensions allowing it to be installed.

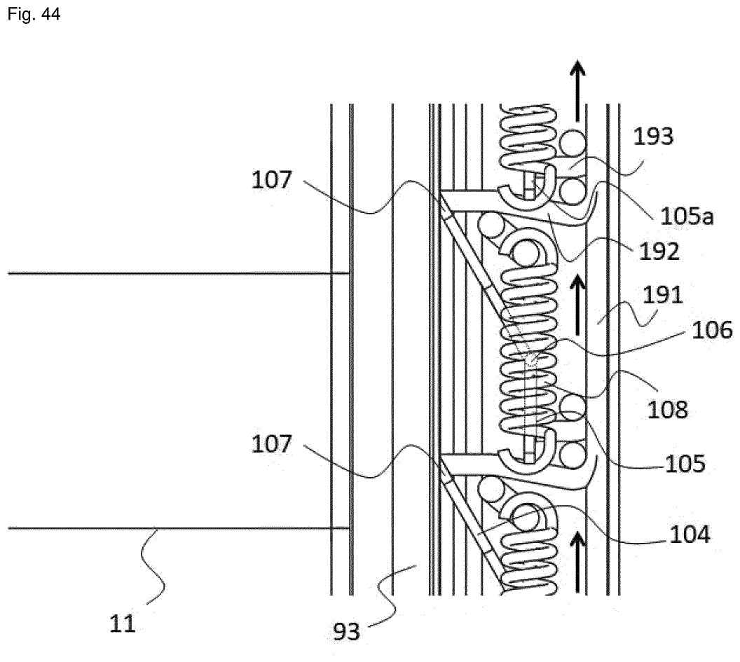

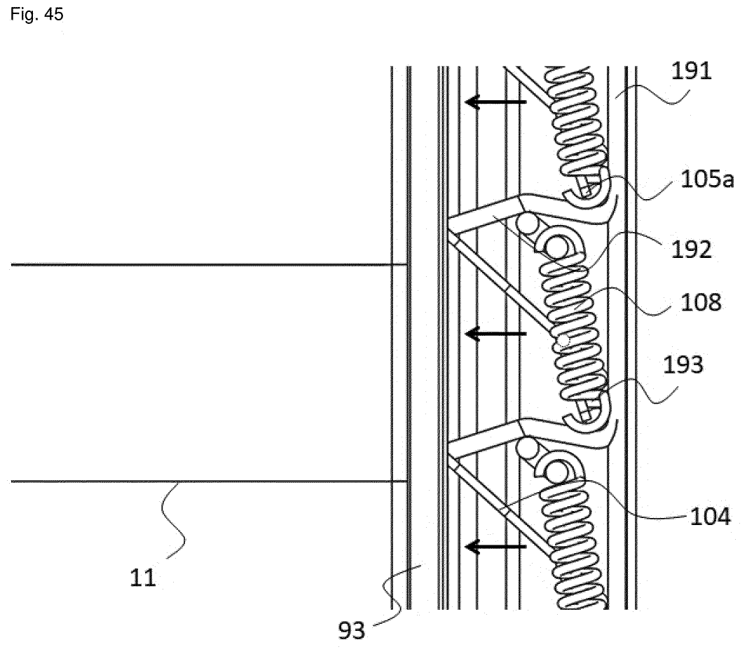

FIGS. 44 and 45 provide a very diagrammatic illustration of a solution wherein the pressing member 100 consists of a double-strand vertical ribbon 191 which extends along each lateral slide 22 and which has first long transverse strands 192 each connected to the end of the long arm 104 of a bistable lever 103 and second short transverse strands 193 each connected to the end 105a of the short arm 105 of the same bistable lever 103. Extension springs 108 such as those described hereinabove allow the levers 103 to have a bistable function. In this alternative aspect, the ribbon 191 consists, for example, of a flat braid from which the long 192 and short 193 strands extend locally. When the ribbon 191 is pulled upwards, for example by a motor and a rotary shaft, the short strands 193 pull on the arms 105 of all of the levers to make them pivot so that they press simultaneously on the vertical clamping bar 93, so that the vertical U-shaped seal gradually compresses the stopper seal 91 in order to create the lateral seal of the closure apron 10 (FIG. 45).

Once the point of stability has been passed, the short strands 193 of the ribbon 191 are no longer under tension, whereas the long strands become tensioned as a result of the rotation of the arm 104 of each lever 103, and the extension springs 108 maintain this position.

By pulling on the ribbon 191 again, it is the long strands 192 this time that pull on the arm 104 of each lever 103 to cause them to pivot in the opposite direction against the pulling force of the springs 108 until they pass the point of stability beyond which said springs 108 pull on the arms 105 to cause the levers 103 to pivot and return to their first stable position, so that the U-shaped vertical seal 91 is separated from the stopper seal 91 of each slat 11.

Alternatively, one ribbon 191 can be provided for the short strands 193 and one ribbon 191 can be provided for the long strands 192, which ribbons are actuated together or separately to alternately activate the long arm 104 or the short arm 105.

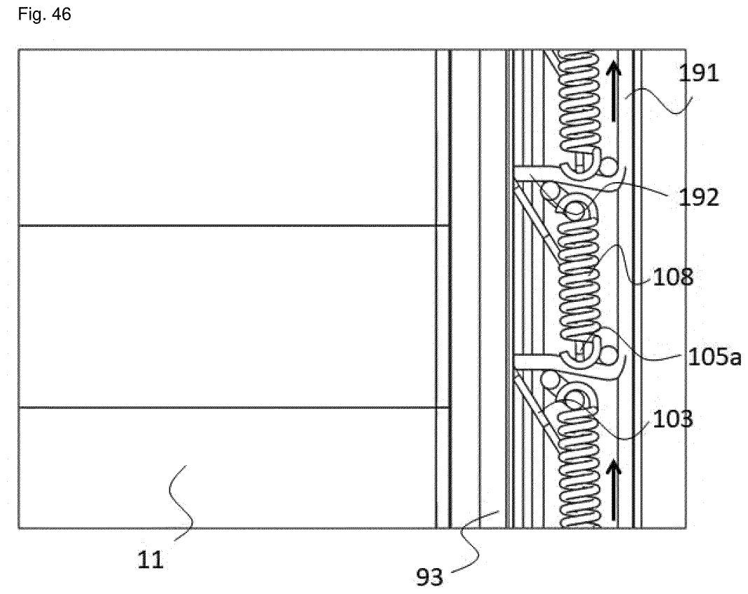

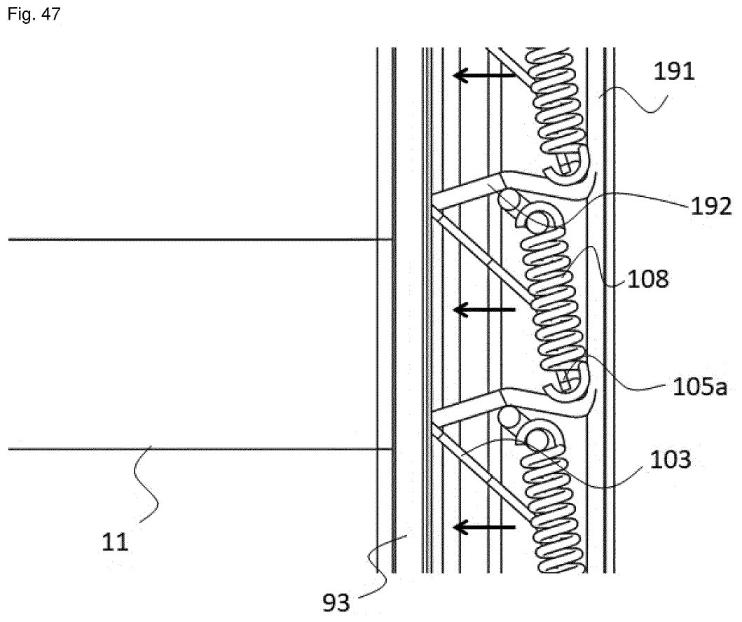

FIGS. 46 and 47 show an alternative aspect to that in FIGS. 44 and 45, wherein the ribbon 191 only has the long strand 192 connected to the arm 104 of each bistable lever 103. In this alternative aspect, the extension spring 108 is under tension when the vertical clamping bar 93 is in the stable, retreated position and so is the ribbon 191, so that the transition of the vertical clamping bar 93 to the advanced position is made by releasing said ribbon 191, which allows the lever 103 to pivot about the pivot pin 106 and the U-shaped vertical seal 92 to move towards the stopper seal 91 (FIG. 47). Means for keeping the ribbon 191 tensioned and for releasing it are of course provided, but are not described. This solution makes it possible to guarantee an “automatic” lateral seal (in the non-activated position), even if the power supply to the means for pulling on the ribbon 191 is cut off.

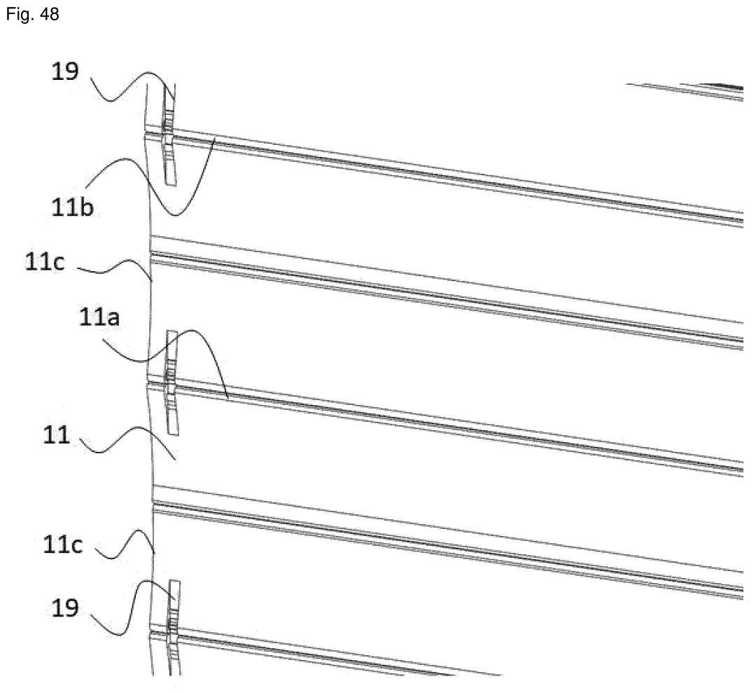

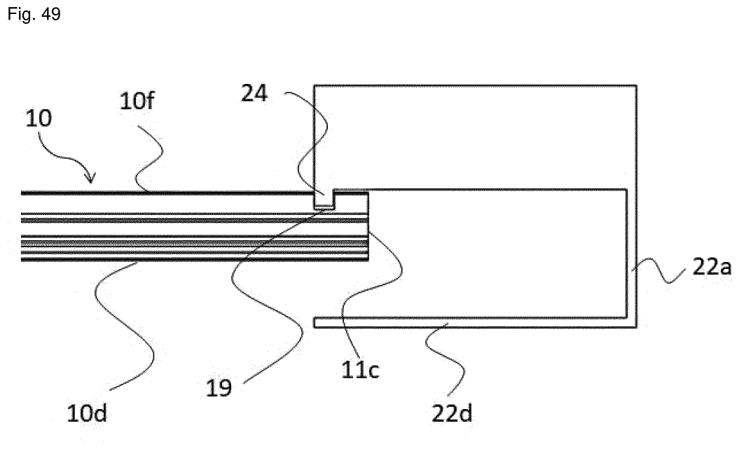

FIGS. 48 and 49 illustrate an improvement to the disclosure, wherein each of the slats 11 is provided, near its two lateral ends 11c, with vertical grooves/slots 19 cooperating with a rib/slide 24 (front and/or rear) provided vertically along the two lateral slides 22 on the front wall 22f so as to guide the up and down movement of the closure apron 10. In particular, this prevents the slats 11 from moving transversally, which could significantly reduce the watertightness of the closure apron 10. Due to the accordion shape of the closure apron 10 in its second lowered position, the vertical slots 19 are alternately disposed close to the upper longitudinal edge 11a or lower longitudinal edge 11b of each slat 11, and they extend over only a portion of the height of each slat 11 due to the frontal curvature thereof.

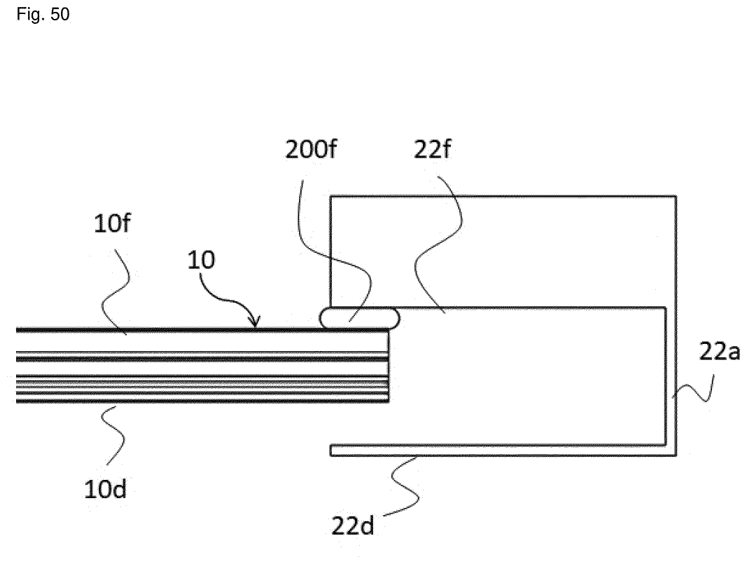

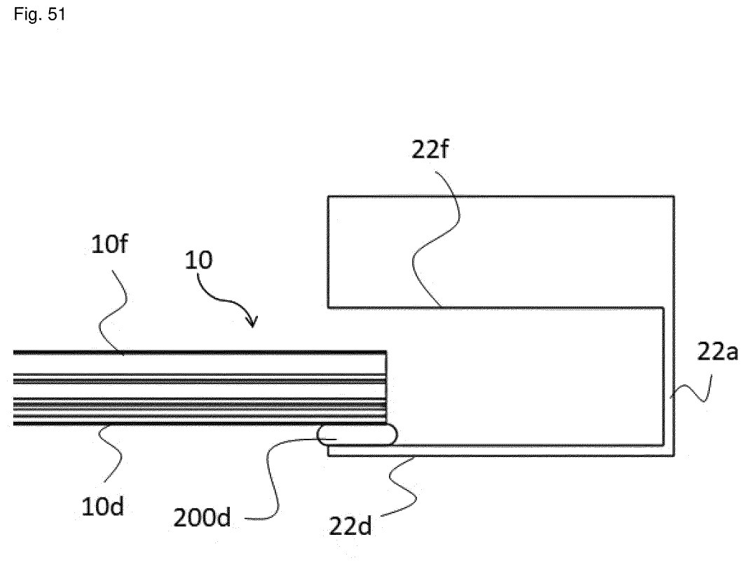

Finally, FIGS. 50 and 51 show improvements to the device 1, wherein sixth lateral low-pressure sealing means 110f and/or 110d consisting, for example, of vertical front seals 200f and/or rear seals 200d in strips, are carried by the front walls 22f and/or rear walls 22d of the lateral slides 22 and, when in use, bear against the front face 10f and/or rear face 10d of the closure apron 10.

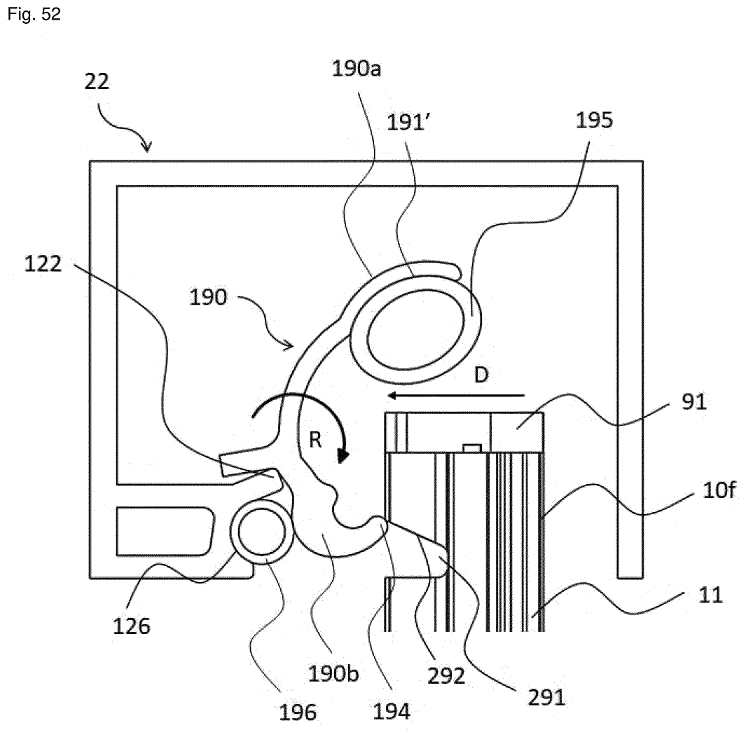

FIGS. 52 to 57 illustrate various alternative aspects of the fifth lateral sealing means 90.

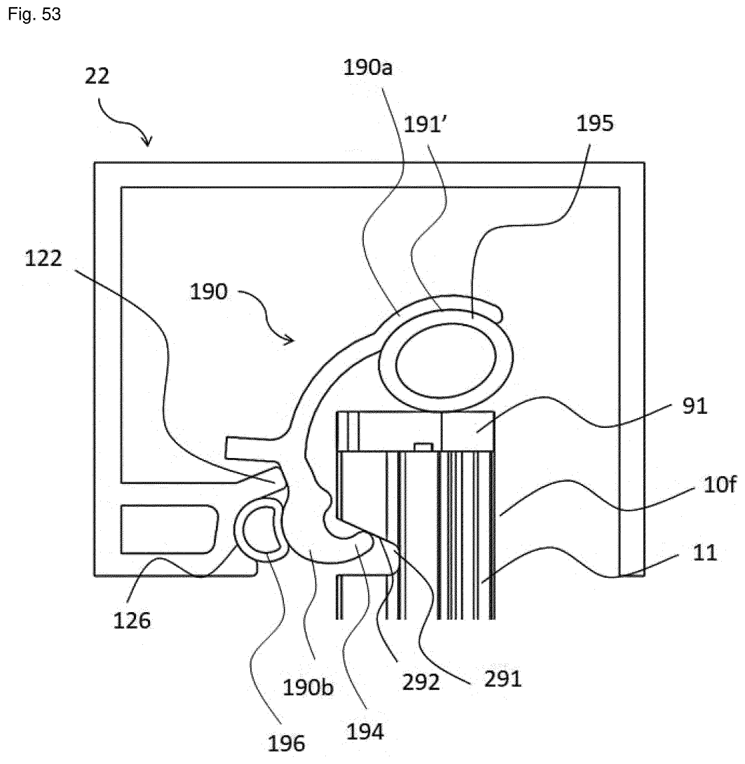

Thus, in FIGS. 52 and 53, the fifth lateral sealing means 90 includes two longitudinal profiles 190 disposed respectively inside the two lateral slides 22 (i.e. one profile 190 per lateral slide 22) and extending vertically on either side of the ends of the slats 11. Each longitudinal profile 190 is substantially crescent-shaped and is hinged about a pivot formed by a stiff rib 122 of the corresponding lateral slide 22. A first free end 190a of the longitudinal profile 190 includes a hollow recess 191′ receiving a first lateral seal 195 (for example a hollow tubular elastomer seal), whereas the opposite end 190b of said longitudinal profile 190, disposed on the other side of the pivot 122, has the overall shape of a hook 194.

The fifth lateral sealing means 90 further includes a second lateral seal 196 (for example also a hollow tubular elastomer seal) held in position inside a hollow recess 126 in the slide 22 having substantially the same shape as said second seal 196 in its unstressed state.

Each longitudinal profile 190 can rotate, about a virtual vertical axis located at its point of contact with the pivot 122, between a first inactive position (FIG. 52) wherein the first lateral seal 195 does not exert any pressure on the stopper seal 91 of the slats 11, and at least a second active position wherein said first lateral seal 195 exerts a first pressure on said stopper seal 91 and the second lateral seal 196 exerts a first pressure against the hollow recess 126 in the lateral slide 22 as the pressure F is exerted on the front face 10f of the closure apron 10, in the lowered position thereof, in order to laterally seal the device 1 against said fluid when water tries to infiltrate on either side of the closure apron 10 (it should be recalled that the inter-slat seal is already set).

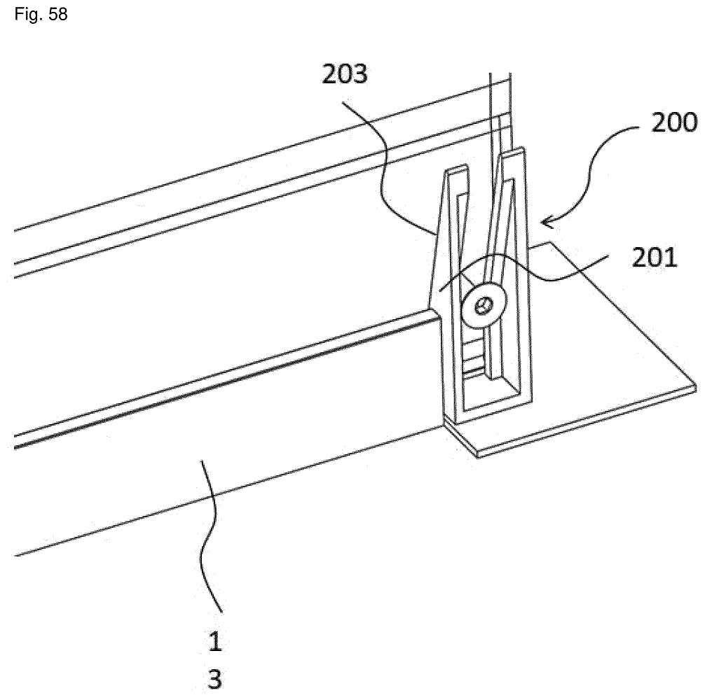

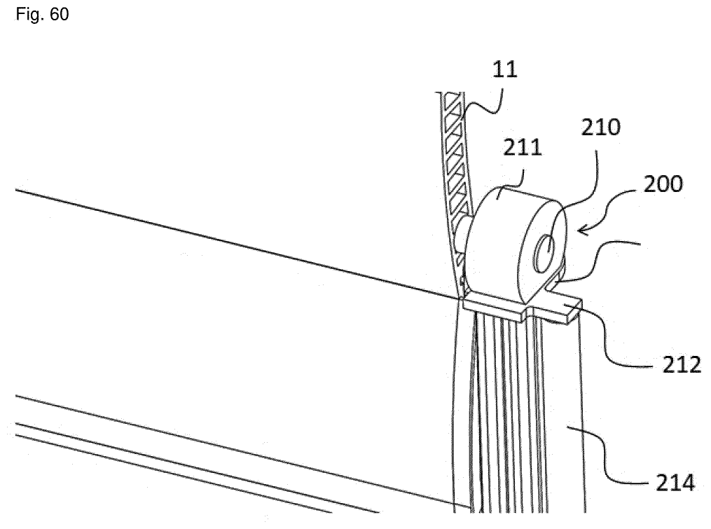

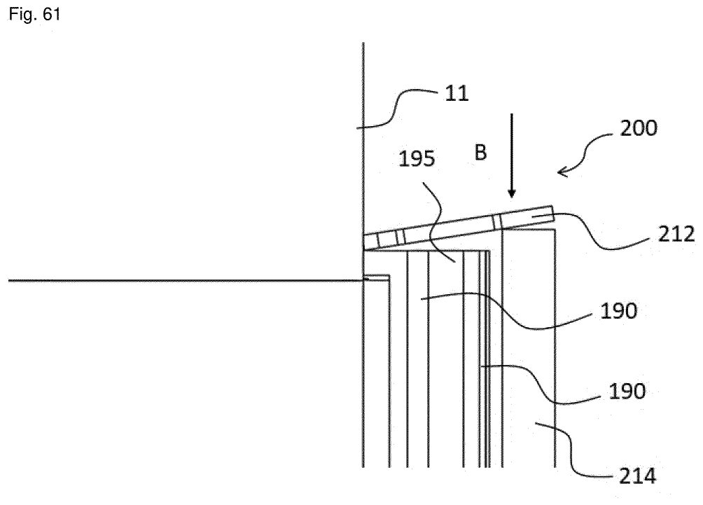

More specifically, the rotation of each longitudinal profile 190 about the pivot 122 (arrow R in FIG. 52) is caused by the displacement (retreat) along arrow D (FIG. 52) of certain slats 11 of the closure apron 10 from the outside of the building 1 towards the inside thereof by means of an activation means 290 described in more detail hereinbelow with reference to FIGS. 58 to 62.

This movement of the slats 11 along arrow D allows an inclined plane 292 of a vertical slot 291, formed in the thickness of the rear face 10f of the lateral slat ends 11 concerned, to press on the rounded end of the hook 194 to cause the longitudinal profile 190 to pivot. In practice, the slats 11 concerned by the fifth lateral sealing means 90 will be those located, once the closure apron 10 is fully lowered, for example at less than about 1 m 20 from the ground, i.e. between about 12 and 24 slats depending on the average height thereof.

FIG. 53 illustrates a “low” sealing position wherein the given slat 11 is retreated along arrow D to cause the longitudinal profile 190 to pivot so that its first end 190a compresses the first lateral seal 195 against the stopper seal 91 of the slats 11 and so that the rear of the hook 194 of the second end 190b of the longitudinal profile 190 compresses the second lateral seal 196 against the hollow recess 126 in the lateral slide 22.

Any water that might have infiltrated the sides of the slats 11, inside the lateral slides 22, therefore cannot enter the interior of the building, which is thus protected by said seals 195 and 196, which form a lateral seal.

Moreover, the more the water rises against the closure apron 10 and inside the lateral slides 22, the more the force that it exerts tends to press on its front face 10f, and the more the longitudinal profile 190 turns vertically about the pivot 122 to compress, during its rotational motion, the two lateral seals 195 and 196, so as to produce a so-called “high-pressure” passive seal. To summarise, the higher the risk of flooding, the greater the watertightness, which makes this device particularly advantageous, especially as it is purely mechanical and thus requires no external means to operate, and in particular no power source.

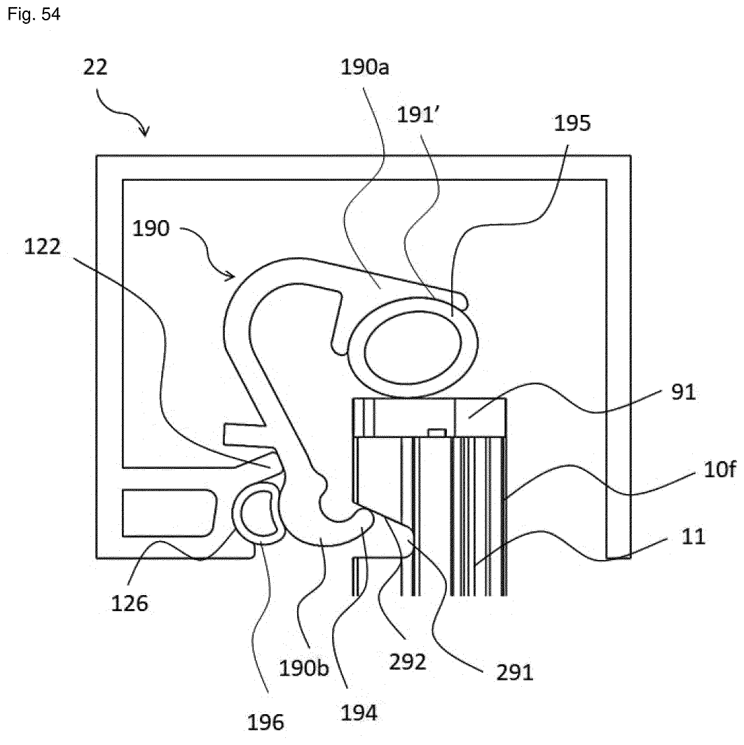

The alternative aspect in FIG. 54 shows a fifth lateral sealing means 90 wherein the longitudinal profile 190 has a slightly different crescent shape which modifies the distribution of the compression forces of the lateral seals 195 and 196, while of course retaining the same pivoting tilt principle.

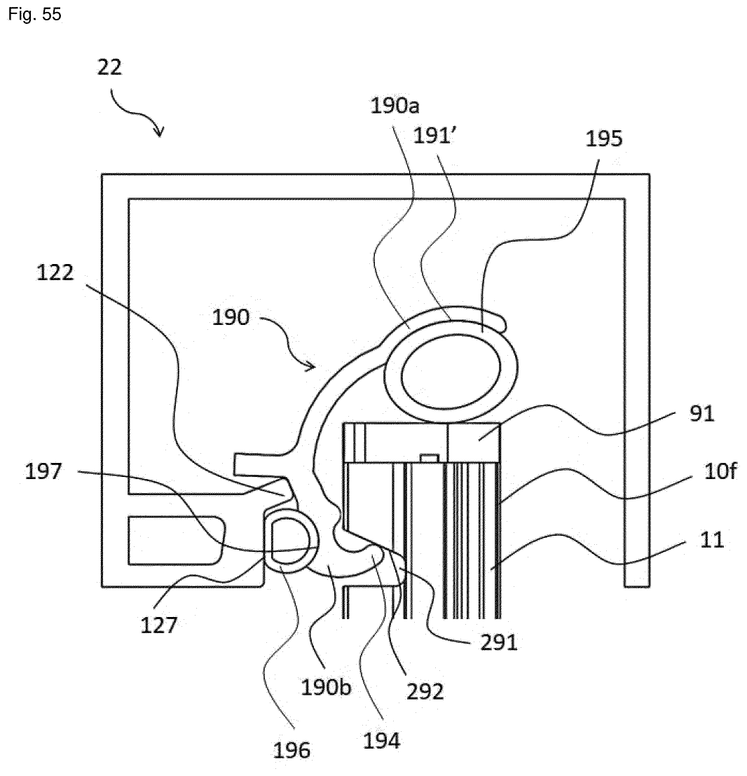

FIG. 55 shows a fifth lateral sealing means 90 wherein the second free end 190b of the longitudinal profile 190 is provided with a hollow recess 197 for receiving the second lateral seal 196 in place of the hollow recess 126 of the lateral slide 22, which thus becomes a flat abutment surface 127 against which said second lateral seal 196 is compressed.

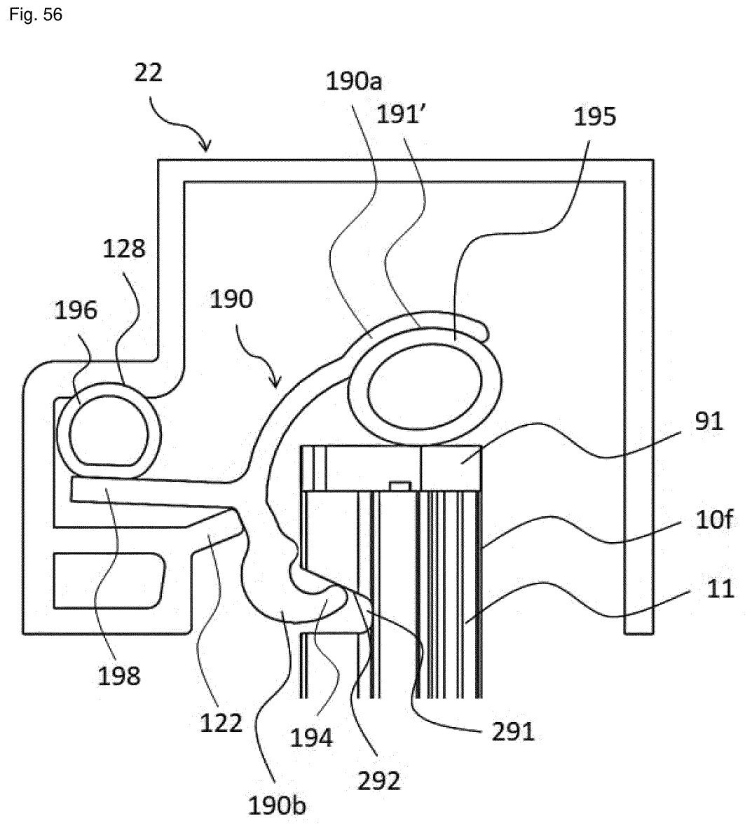

FIG. 56 shows a fifth lateral sealing means 90 wherein the longitudinal profile 190 is provided with an intermediate rear rib 198 located immediately before the pivot 122 of the lateral slide 22. This rear rib is located facing the second lateral seal 196 and gradually compresses it, from the second position of the longitudinal profile 190, against a front inner wall 128 of the lateral slide 22 acting as a stop.

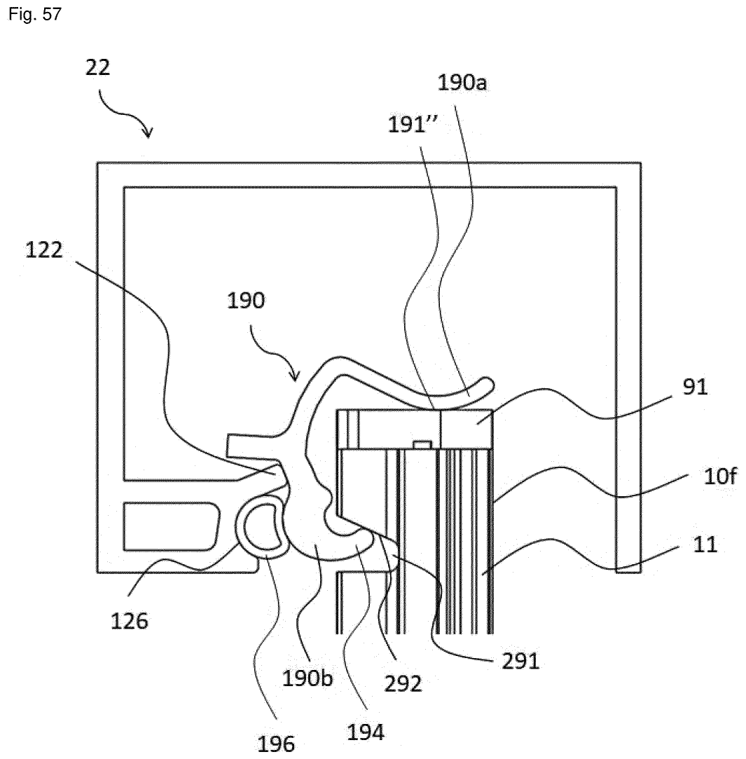

FIG. 57 shows a fifth lateral sealing means 90 wherein the shape of the first free end 191 of the longitudinal profile 190 is modified to form a type of spoon with a rounded area 191″ which presses directly against the stopper seal 91, without the presence of the first lateral seal 195.

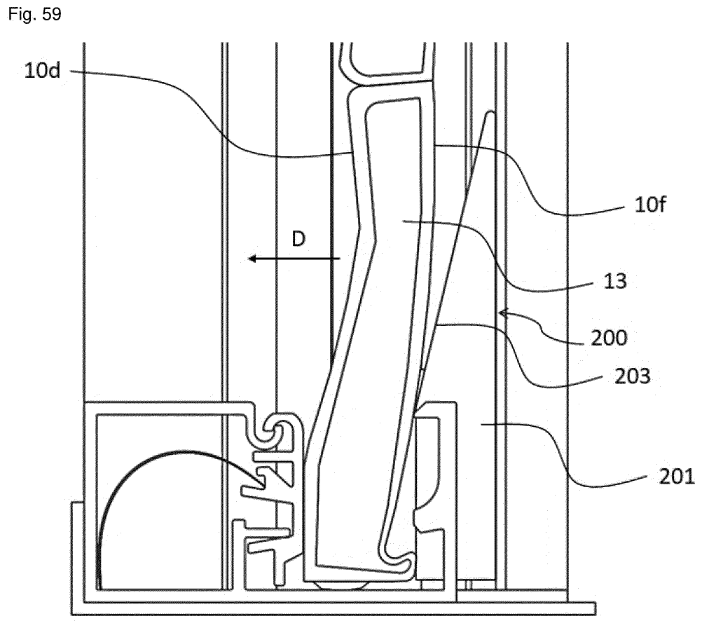

FIGS. 58 and 59 show a system 200 for activating the translational movement (arrow D in FIG. 52) of the lower slats 11 and the rotational movement (arrow R in FIG. 52) of the longitudinal profiles 190.

More specifically, this activation system includes two lower ramps 201 positioned against or inside each lateral slide 22, each ramp having an inclined plane 203 oriented upwards from the inside to the outside (N.B.: of the building). Thus, when the bottom slat 13 descends, due to the weight of the closure apron 10, its front face 10f comes into contact with the inclined plane 203, which is unmoving, causing said slat to retreat from the outside of the building towards the inside (arrow D in FIG. 52). As explained hereinabove, this retreating movement of the slat causes the inclined plane 292 of the slot 291 to bear against the rounded end of the hook 194, which pivots (arrow R in FIG. 52), causing the entire longitudinal profile 190 to rotate and the two lateral seals 195 and 196 to be compressed against the stopper seal 91 and the slide 22 respectively (hollowed out area 126, flat surface 127 or stop 128).

When the closure apron 10 is lowered, the longitudinal “lever” profiles 190 each begin to pivot vertically to position the two lateral seals 195 and 196 in contact respectively with the stopper seals 91 and the corresponding portions of the lateral slides 22. However, beyond mere contact, these seals must be pressed down (via the longitudinal lever profiles) to procure a low-pressure and then a high-pressure seal. To this end, the activation system 200 further includes an assembly of moving parts including an upper roller 210, preferably covered with a flexible sleeve 211 (elastomer), connected to one end of a given slat 11 and adapted to bear against a lateral distribution plate 212, which is itself placed on a vertically-moving, longitudinal bar 214 resting on a lower, curved, lateral clamping sheet 216.

Thus, when the closure apron 10 is unrolled and descends, the slat 11, whose lateral ends are provided with two rollers 210, accompanies this descending movement. Each roller 210 thus exerts a downward vertical force (arrow B) on the distribution plate 212, which causes the vertical bar 214 to descend by pressing on the lower, curved, clamping sheet 216, which then presses laterally (arrow L) on the longitudinal profile 190 to force it to rotate vertically and cause the two lateral seals 195 and 196 to be compressed.

Thus, the more the closure apron 10 descends, the further the bottom slat 13 retreats thanks to the ramps 201, which causes the longitudinal profiles 190 to switch from the first position to the second position. Moreover, the more the closure apron 10 descends, the more the rollers 210 press on the vertical bar so as to cause the lateral profiles to pivot and hold them in their low-pressure sealing position and then their high-pressure sealing position as the water rises against the front face 10f of the closure apron 10.

Again, the system is totally passive (there is no need for an external power source).

A compression member (of the spring type) can also be positioned on each longitudinal profile 190 when in its initial vertical position, and can be attached, for example, between the upper support roller 210 and the top end of the profile. The vertical support of the longitudinal profile 190 is thus guaranteed, even if the position of the upper support roller 210 varies.

The fifth lateral sealing means 90 preferably includes a sensor for automatically detecting rising water so as to be able to automatically (without action by a person) trigger activation of the pressing member so as to create the lateral seal. A humidity sensor of a known type can be used. This sensor can also be used upstream to rotate the shutter so that it descends completely, then lock it in the lower channel. An anemometer can also be used for the same purpose of automatically activating the shutter in the event of a storm.

By its very nature, this anti-flooding device is thus designed to be activated without limitations, and whenever nobody is present in the premises protected. In principle, there is no need for an external power source to protect the building in the event of flooding: all sealing is mechanically passive (no need to rely on sensors). The fittings required to install the device are lightweight and can be used in both new-build and renovation projects. It requires cuts a few centimetres wide to be made in the floor and side walls to accommodate the lateral slides and the lower channel.

Secondly, this device offers a subtle balance between high stiffness, which allows it to resist the push of the water over a significant height (1.5 m water height for a 1.8 m wide sash, for example, which was totally inconceivable with solutions of the prior art), a dissociation of the slats allowing them to be flexibly rolled up without hindrance, and a double seal: a low-pressure seal for low water heights, and a so-called passive, high-pressure seal, which increases with the height of the water, and thus the frontal pressure exerted on the closure apron. The seal between the slats is placed in the slats, and thus has no mechanical weaknesses.

These three features, which must perform well for the innovation to work, are dependent on potentially contradictory factors. For example, the apron must be very stiff to withstand the water, and very flexible to be able to roll up. In the same way, the seal must have flexible parts that conform to one another, in contradiction with the need for the apron to be stiff.

The relatively high level of difficulty involved in designing a solution that discriminates between these behaviours and achieves good performance on all three features suggests that this solution is particularly innovative and effective because of the many issues it overcomes.

In addition to its anti-flooding performance, the particularly high stiffness of the apron provides excellent anti-intrusion and storm protection functions (protection against flying objects).

It should be clearly understood that the detailed description of the subject matter of the disclosure, which is given solely by way of illustration, in no way constitutes a limitation, and that technical equivalents also fall within the scope of the present disclosure.

Therefore, the shape of the seals, the slat profiles, the number of springs or the number of levers can vary according to requirements, the geographical location of the device and the risks involved (areas with high or low flood risks, subject to storms and/or intruders), the dimensions of the opening (height and width) and thus those of the closure apron 10.

Optionally, a flexible cord can be inserted at the rear of the bottom slat 13, which is pressed against the rear of the lower channel as the water rises, thus improving the high-pressure seal.

The pressure shoe 107 can be mounted on a ball joint link to conform as closely as possible to the shape (and any deformations) of the vertical clamping bar 93.

A system of lateral wedges sliding vertically in the slides 22 can be used to move the vertical clamping bar 93.

It goes without saying that the pressing system could be actuated occasionally, and not each time the shutter is lowered, either by a command that the user intentionally actuates (for example, another position in the shutter closure command: open, partially closed, fully closed but without the watertight mode, fully closed with the watertight mode), or by a command triggered when the water rises.

This passive triggering of the actuation could take place in several ways, either using a float-type sensor connected to an electrical actuator (the float, driven by the rising water, would trigger the locking control), or using a conduction sensor connected to an electrical actuator (the presence of water would close rather than open an electrical circuit, thus allowing the locking control to be actuated).

The device is suitable for sectional garage or warehouse doors, which are often very wide (2 to 5 m, for example) and have much higher slats (10-50 cm).

The device can also be designed to withstand extremely strong gusts of wind in excess of 200 km/h and/or water heights in excess of 1.50 to 1.80 m. This would in particular involve adapting the size of the seals and the slats.

What is claimed is:

1. Roller shutter-type rollable occlusion device for closing an opening such as a door, a window or a bay window of a residential building such as a private or collective dwelling, or of an industrial building such as a shop, a factory, a garage/car park or a warehouse, said closing device comprising an external frame mounted in the opening and provided with at least two lateral guiding slides with a U-shaped cross-section facing one another, in order to define a general closure plane, and a set of transverse slats hinging relative to one another in pairs by the respective longitudinal edges thereof, the slats-sliding within the two lateral slides between a first inactive raised position in which said slats are rolled up around an upper transverse shaft and a second active lowered position in which said slats are unrolled and form an apron for closing said opening,
characterised in that:
the cross-section of the lateral slides is greater than the thickness of the slats,
in the second, active lowered position of the closure apron, the slats-adopt a vertical accordion configuration in the lateral slides and form, relative to one another consecutively in pairs, front and rear angles not equal to 180°, and
in a third lowered position, the slats adopt a protective and reinforced fluid-tight configuration, referred to as the position under frontal load, when the closure apron is subjected to a force on a front face, for example the pressure exerted by a height of water, so that the slats form, relative to one another consecutively, an angle as close as possible to 180°, or even equal to 180°, so that the closure apron is disposed in the general closure plane or parallel thereto.

2. Device according to claim 1, characterised in that, in the second active lowered position, the slats are alternately inclined in a repeated and regular manner at identical front and rear angles respectively.

3. Device according to claim 2, characterised in that, in the second active lowered position, the absolute values of the front and rear angles are identical.

4. Device according to claim 1, characterised in that the absolute value of each rear and front angle is comprised between about 90° and 179°, preferably between about 125° and 175°, and advantageously between 150° and 170°.

5. Device according to claim 1, characterised in that it comprises a first longitudinal means for creating a passive seal between the slats supporting a low-pressure from a fluid.

6. Device according to claim 5, characterised in that the first longitudinal low-pressure passive sealing means includes at least, on a lower longitudinal edge of a given first slat, a prominent transverse rib and, on an upper longitudinal edge (11a) of a slat that is below said given first slat, a transverse groove enclosing a first flexible, transverse seal, said prominent, transverse rib increasingly compressing said first flexible, transverse seal in the transverse groove so as to progressively compress the latter as the slats move from the second position to the third lowered sealing position, so as to seal the device against fluid.

7. Device according to claim 5, characterised in that the first longitudinal low-pressure passive sealing means includes at least, on the lower longitudinal edge of a given first slat, a transverse groove enclosing a flexible, transverse seal and, on an upper longitudinal edge of a slat that is below said given first slat, a prominent, transverse rib, said prominent, transverse rib increasingly compressing said first flexible, transverse seal in the transverse groove so as to progressively compress the latter as the slats move from the second position to the third lowered sealing position, in order to seal the device against fluid.

8. Device according to claim 5, characterised in that the first transverse seal is a strip with a polygonal, circular or oval cross-section.

9. Device according to claim 5, characterised in that the first seal is made of silicone or EPDM rubber.

10. (canceled)

11. Device according to claim 1, characterised in that it further comprises a second longitudinal means for creating a passive seal between the slats supporting a high-pressure from a fluid.

12-14. (canceled)

15. Device according to claim 1, characterised in that it further includes:
lower, transverse channel connecting the two lateral slides and intended to receive at least one bottom end slat of the closure apron, and
at least a third longitudinal, passive, low-pressure sealing means.

16. Device according to claim 15, characterised in that the third longitudinal, passive, low-pressure sealing means includes:
a third flexible transverse seal rigidly connected to a lower longitudinal edge of the bottom end slat, and
a bottom wall of the lower channel so that, in the third lowered sealing position, the third flexible transverse seal is compressed against said bottom wall in order to seal the device against said fluid.

17. Device according to claim 15, characterised in that the third flexible transverse seal is positioned in a transverse groove rigidly connected to a bottom wall of the lower channel so that, in the third lowered sealing position, the third flexible, transverse seal is compressed between a lower longitudinal edge of the bottom end slat and said transverse groove in order to seal the device against said fluid.

18. Device according to claim 15, characterised in that the lower channel includes a protective covering comprising a hinged upper cover, a leaf spring bearing against a bottom wall of said lower channel and said closure cover, and a hook provided on a rear wall of the channel and capable of cooperating with a corresponding hook provided along the lower edge of the bottom slat to form an anti-unhooking/separation device so that, in the second position, the third flexible, transverse seal bears against the closure cover and, in the third lowered sealing position, the hooks are engaged to prevent any inadvertent raising of the closure apron.

19. Device according to claim 18, characterised in that anti-unhooking/separation device consists of a plurality of hooks spaced apart and distributed transversally along the lower edge of the bottom end slat.

20. Device according to claim 1, characterised in that each lateral slide houses a fifth lateral sealing means.

21. Device according to claim 20, characterised in that the fifth lateral sealing means includes a flexible stopper seal penetrating recesses in the respective lateral ends of each of the slats.

22-36. (canceled)

37. Device according to claim 22, characterised in that the pressing member includes a reversible expansion joint which bears against each stopper seal and fills the space between the latter and the bottom wall of the corresponding lateral slide.

38. Device according to claim 37, characterised in that the reversible expansion joint is of the hydraulic or pneumatic type.

39. Device according to claim 37, characterised in that the reversible expansion joint is of the chemical expansion type.

40-41. (canceled)

42. Device according to claim 21, characterised in that the fifth lateral sealing means includes two longitudinal profiles disposed inside the two lateral slides on either side of the ends of the slats, each longitudinal profile being provided, for the slats disposed facing said longitudinal profile, with a first lateral seal and a second lateral seal, said profile being hinged about a vertical shaft between:
a first inactive position in which the first lateral seal does not exert any pressure on the stopper seal of the given slat, and
at least a second active position in which the first lateral seal exerts lateral pressure on said stopper seal and the second lateral seal exerts pressure against a portion of the lateral slide as pressure is exerted on the front face of the closure apron, when the latter is in the lowered position, in order laterally seal the device against said fluid.

43. Device according to claim 42, characterised in that:
the longitudinal profile includes a curved crescent shape defining a lever hinged about a pivot formed by an internal rib of the corresponding lateral slide, a first free end of said profile being provided internally with the first lateral seal, whereas a second opposite end located on the other side of the pivot, is disposed facing the second lateral seal, and
when the longitudinal profile is in the second position, the first free end thereof compresses the first lateral seal against the stopper seal of a given slat and the rear of the second free end (190b) thereof compresses the second lateral seal against a portion of the corresponding slide.

44. Device according to claim 43, characterised in that the slide has a hollow recess close to the pivot for receiving the second lateral seal in order to hold it in position.

45. Device according to claim 43, characterised in that the rear of the second free end of the longitudinal profile is provided with a hollow inner recess for receiving the second lateral seal in order to hold it in position.

46. Device according to claim 42, characterised in that:
the longitudinal profile includes a curved crescent shape defining a lever hinged about a pivot formed by an internal rib of the corresponding lateral slide, a first free end of said profile being provided internally with the first lateral seal, whereas a rear rib fitted between the two free ends of the profile, is disposed facing the second lateral seal, and
when the longitudinal profile is in the second position, the first free end thereof compresses the first lateral seal against the stopper seal of a given slat and the rear rib thereof compresses the second lateral seal against a rear edge of the corresponding slide.

47. Device according to claim 42, characterised in that the first free end of the longitudinal profile is provided with a hollow inner recess for receiving the first lateral seal in order to hold it in position.

48. Device according to claim 42, characterised in that the second free end of the longitudinal profile includes a hook disposed facing a vertical rear slot formed in the thickness of at least some of the lower slats, such that the pressure exerted by the water on the front face of the closure apron, when in its lowered position, causes said given slats to retreat and the hook to slide along an inclined plane of said vertical slot, in turn causing the longitudinal profile to progressively rotate about the pivot and increasing the force exerted on the stopper seal as said pressure increases.

49. Device according to claim 42, characterised in that the fifth lateral sealing means further includes a system for activating the longitudinal profiles, which system is disposed in the lower part of each lateral slide, said activation system causing at least the bottom slat to advance from the front face towards the rear face of the closure apron as the slats descend along the lateral slides, so as to tilt the longitudinal profiles from the first position into the second position.

50. Device according to claim 49, characterised in that each activation system includes a ramp having a vertical plane that is inclined from the rear face to the front face of the closure apron along which the bottom slat slides as it descends.

51. Device according to claim 50, characterised in that each activation system further includes an upper roller connected to one end of a given slat and adapted to bear against a lateral distribution plate, which is itself placed on a vertically moving, longitudinal bar resting on a lower, curved, lateral clamping sheet, such that the descent of the upper roller exerts a vertical force directed downwards on the distribution plate, which causes the vertical bar to descend, pressing on the lower, curved clamping sheet which thus presses laterally on the longitudinal profile to cause it to rotate vertically and create the lateral seal on the given lower slats.

52. Device according to claim 51, characterised in that each longitudinal profile is provided with a compression member in the initial vertical position, including a compression spring connected between a top end of said longitudinal profile and the corresponding upper support roller.

53. (canceled)

54. Device according to claim 1, characterised in that each lateral slide is provided, on at least one of the walls thereof, with a vertical rib penetrating a vertical groove in each slat so as to block the latter in the lateral slide at least in the third lowered sealing position.

55. (canceled)
